(19) United States
(12) Patent Application Publication
(10) Pub. No.: US 2026/0278135 A1
(43) Pub. Date: Sep. 17, 2026

(54) Provisioning Cloud Resources on Computing Devices Based on Natural Language Descriptions of Physical Protection

(71) Applicant: Oracle International Corporation, Redwood Shores, CA (US)

(72) Inventors: William Nickolas Moran, Austin, TX (US); Zachary Gilburd, Seattle, WA (US)

(73) Assignee: Oracle International Corporation, Redwood Shores, CA (US)

(21) Appl. No.: 19/337,119

(22) Filed: Sep. 23, 2025

Related U.S. Application Data
(60) Provisional application No. 63/771,359, filed on Mar. 13, 2025.

(51) Int. Cl. G06F 21/62

(52) U.S. Cl. CPC G06F 21/6218

(57) ABSTRACT

The present disclosure relates to methods and systems for protecting cloud resources. The methods and systems may use a virtual gatekeeper resource to enforce secure access controls to cloud resources for a list of privileged operations. The cloud resources and the virtual gatekeeper resource may be in different security domains within a cloud computing system and the cloud resources may be linked to the virtual gatekeeper resource. A request may be sent to perform a privileged operation on the cloud resource. Access may be provided to the virtual gatekeeper resource in response to approval of the request and the access to the virtual gatekeeper resource may be used to perform the privileged operation on the cloud resource.

### BENEFIT CLAIMS; RELATED APPLICATIONS; INCORPORATION BY REFERENCE

The following applications are hereby incorporated by reference: U.S. Provisional Patent Application 63/771,359, filed Mar. 13, 2025, and U.S. patent application Ser. No. 19/319,552 filed Sep. 4, 2025.

### TECHNICAL FIELD

The present disclosure relates to controlling access to computing systems. More specifically, the disclosure is directed to securing cloud resources provisioned in cloud computing facilities.

### BACKGROUND

A datacenter is a facility that provides physical infrastructure that houses computing hardware shared among multiple users such as customers of a cloud computing service. Because the infrastructure is shared, the facility allocates portions of the hardware among the users. The users then store data or execute workloads on the allocated hardware using, for example, virtualization technologies, container orchestration systems, or bare-metal provisioning mechanisms. The workloads of some users involve confidential data that require protection from the other users. For example, one of the users may be a medical service provider that manages confidential patient data. To maintain confidentiality, the medical service provider may require its workloads to be processed on devices that are isolated from other users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1A illustrates an example cloud resource architecture in accordance with one or more embodiments;

FIG. 1B illustrates an example cloud management system in accordance with one or more embodiments;

FIGS. 2A, 2B, and 2C illustrate an example set of operations for provisioning cloud resources in accordance with one or more embodiments;

FIG. 3 is a block diagram illustrating an example data structure storing a datacenter model in accordance with one or more embodiments;

FIG. 4 is a block diagram illustrating a model of multilevel mapping between physical and logical elements in a datacenter in accordance with one or more embodiments;

FIG. 5A is a block diagram illustrating an example embodiment of a datacenter in accordance with one or more embodiments;

FIG. 5B is a block diagram illustrating an example data structure associating a protection level with protection criteria in accordance with one or more embodiments;

FIGS. 6-9 are block diagrams illustrating patterns for implementing a cloud infrastructure as a service system in accordance with one or more embodiments; and

FIG. 10 is a hardware system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The term “cloud computing service” or “cloud service” is generally used to refer to a service that is made available by a cloud services provider (CSP) to users or customers on demand (e.g., via a subscription model) using systems and infrastructure (cloud infrastructure) provided by the CSP.

In most cases, the CSP is a third-party service that specializes in providing (e.g., offering, renting, selling) cloud services to customers. The servers and systems that make up the CSP's infrastructure are separate from the customer's own on-premise servers and systems.

Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services. In some instances, an entity might opt to deploy a private cloud, becoming its own provider of cloud services. In some instances, an entity may utilize both a private cloud and a public cloud provided by a third-party CSP, thereby forming a hybrid cloud.

There are several cloud service providers that offer various types of cloud services. There are various different types or models of cloud services including Software-as-a-Service (SaaS), Platform-as-a-Service (PaaS), Infrastructure-as-a-Service (IaaS), and others. In an IaaS model, the CSP provides infrastructure (referred to as “cloud services provider infrastructure” or “CSPI”) that can be used by customers to build their own customizable networks and deploy customer resources.

A customer can subscribe to one or more cloud services provided by a CSP. The customer can be any entity, and the like. When a customer subscribes to or registers for a service provided by a CSP, a tenancy, or an account, is created for that customer. The customer can then, via this account, access the subscribed-to one or more cloud resources associated with the account.

### Table of Contents

1. GENERAL OVERVIEW
2. PRACTICAL APPLICATIONS, ADVANTAGES & IMPROVEMENTS
3. CLOUD RESOURCE ARCHITECTURE
4. CLOUD MANAGEMENT SYSTEM
5. PROVISIONING CLOUD RESOURCES ON COMPUTING DEVICES BASED ON NATURAL LANGUAGE DESCRIPTIONS
6. EXAMPLE EMBODIMENTS
7. EXAMPLES OF CLOUD INFRASTRUCTURE
8. COMPUTER SYSTEM
9. MISCELLANEOUS; EXTENSIONS

### 1. General Overview

One or more embodiments control provisioning of cloud resources on physical computing devices in CSPI, such as a datacenter, based on a natural language request describing protection requirements. Prior to provisioning a cloud resource to one or more of the computing devices, the system determines a prompt for an artificial intelligence (AI) model that causes the AI model to generate an output identifying protection levels that correspond to multiple protection dimensions of the CSPI, such as access control, surveillance, environmental monitoring, and isolation. Based on the protection level and associated protection criteria, the system determines if protection capabilities of the computing devices satisfy the request.

For example, when requesting provisioning of the cloud resource, the user may input the natural language statement, “Workloads on the computing resource must be protected from unaudited execution, protected from third-party presence, and executed on a server rack having redundant surveillance that is auditable.” In response, the system submits a prompt to the AI model that causes the AI model to return a response having a protection levels for the computing devices that have protection criteria that specify protection mechanisms meeting the requirements of the request, such as a tenant-dedicated room with independent entry, access limited to a predefined set of authorized personnel, and continuous visual surveillance with at least two cameras and retained for at least 180 days.” The system then identifies computing devices available to execute or store the cloud resource and determines the capabilities of protection mechanisms that correspond to the candidate computing devices. For example, the system identifies security device associated with the computing devices and evaluates configurations, current alerts, or faults of the devices. Based on the associated security devices and their states, the system determines if the protection afforded by at least one candidate computing device meets the protection levels. If so, the system initiates the provisioning of the cloud resource on the computing device.

In one or more embodiments, a system receives a natural language input describing protection desired for a target cloud resource. The natural language input may define protection requirements for any physical computing device that is to be selected by the system to execute or store the target cloud resource. The system submits the natural language input to an AI model to determine one or more sets of target protection levels for any physical computing device(s) that is to be configured to execute or store the target cloud resource. The system receives the set of target protection criteria from the AI model and identifies a physical computing device that currently meets the set of protection level. Responsive to identifying the physical computing device, the system initiates the executing or storing of the target cloud resource on the selected physical computing device.

One or more embodiments described in this Specification and/or recited in the claims may not be included in this General Overview section.

### 2. Practical Applications, Advantages & Improvements

Embodiments enhance the technical capabilities of systems that protect cloud resources executing within multi-tenant and multi-operator computing facilities, such as a datacenter and other CSPI. Example systems transform unstructured, unspecific natural language provisioning requests into structured, machine-readable protection criteria for cloud resources, computing devices, and protection mechanisms at physical locations of the datacenter. Unlike conventional techniques that merely secure information using logical isolation or access control, example systems substantially increase the protection provided to a cloud resource by determining if a computing device is physically and logically protected prior to provisioning of the cloud resource at the computing device. Moreover, example systems provide the protection without users having specific knowledge or explicitly requesting particular protection policies or levels or a facility's layout, infrastructure, or protection capabilities.

Additionally, one or more embodiments enhance protection of cloud resources within multi-tenant and multi-operator computing facilities by preventing access to the cloud resources by unauthorized entities, such as other tenants and operators. The system selects a computing device for hosting a cloud resource based on the device's physical location and protection levels to ensure that only approved individuals or systems may interact with the cloud resource in accordance with the protection mechanisms or particular cloud resources and workloads. For example, the system may receive a request to provision a virtual machine (VM) at a location that a customer demands exclusive control of during a designated time frame. Before provisioning the VM to a computing device, the system determines if physical locations of the computing device meet the protection criteria derived from the requirements for the VM. In one example, the system may determine if protection mechanisms for a candidate computing device indicate any unauthorized individual has access to the exclusive area of control during the requested time frame. If the protection level of the physical location is insufficient prior to initiating execution, or if the protection level becomes insufficient during execution, the system prevents execution of the cloud resource.

### 3. Cloud Resource Architecture

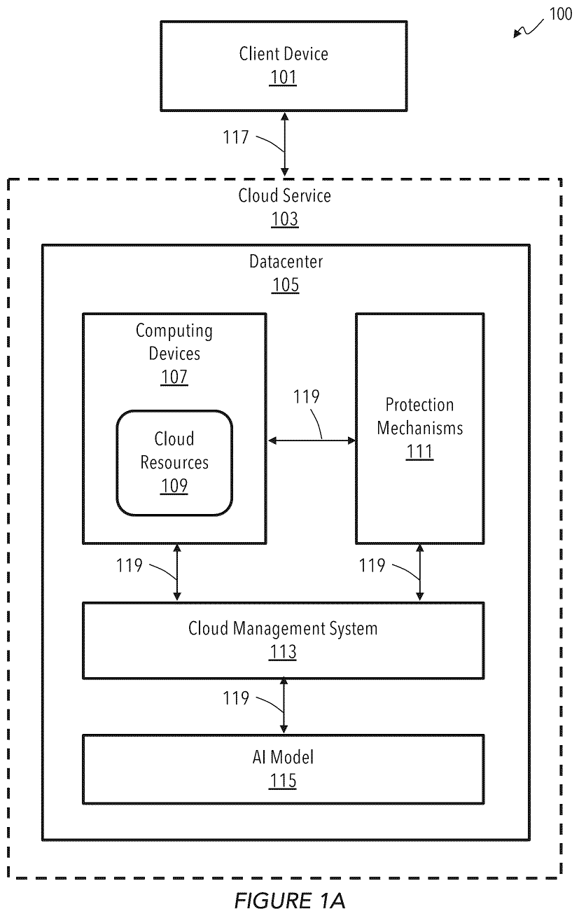

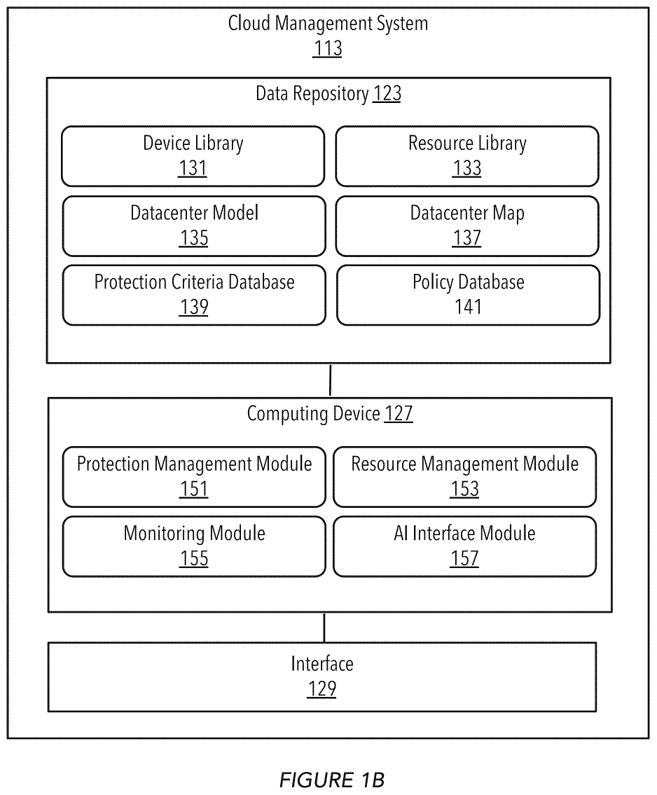

FIG. 1A illustrates an example cloud resource architecture 100 for executing cloud resources in protected locations in accordance with one or more embodiments. As illustrated in FIG. 1A, the architecture 100 includes a client device 101, a cloud service 103, a datacenter 105, computing devices 107, cloud resources 109, protection mechanisms 111, a cloud management system 113, and an AI model 115. As detailed herein, the client device 101 interacts with the cloud service 103 to provision and manage the cloud resources 109 on the computing devices 107 of the datacenter 105. The client device 101 is communicatively connected, directly or indirectly, with the computing devices 107, the protection mechanisms 111, and the cloud management system 113 via one or more communication links 117. In one or more embodiments, the architecture 100 may include more or fewer components than the components illustrated in FIG. 1A. The components illustrated in FIG. 1A may be local to or remote from one another. The components illustrated in FIG. 1A may be implemented in software and/or hardware. Each component may be distributed over multiple applications and/or machines. Multiple components may be combined into one application and/or machine.

Operations described with respect to one component may instead be performed by another component.

The client device 101 is a computing system, such as a personal computer, workstation, server, mobile device, mobile phone, tablet device, and/or other processing device capable of implementing and/or executing software, applications, user interfaces, etc. The client device 101 may be operated by a user representing an organization or an enterprise that is a customer, operator, or provider of the cloud service 103. For example, the user may be an employee of a tenant that has subscribed or registered with the cloud service 103.

One or more embodiments of the client device 101 execute and display a computer-user interface that allows a user to access, perceive, and interact with hardware, software, and services of the cloud service 103 and the cloud management system 113. Depending on the implementation, the client device 101 may function as a workstation or a web-based interface, enabling remote access and interaction with the cloud service 103. For example, cloud data management system 113 may generate a console for the cloud management system 113 at the client device 101 that enables the user to configure, access, and manage the cloud resources 109 deployed in the datacenter 105 by a tenant. The console may be web-based user interface or client application that generates the graphic user interface (GUI) for a computer-user interface at the client device 101.

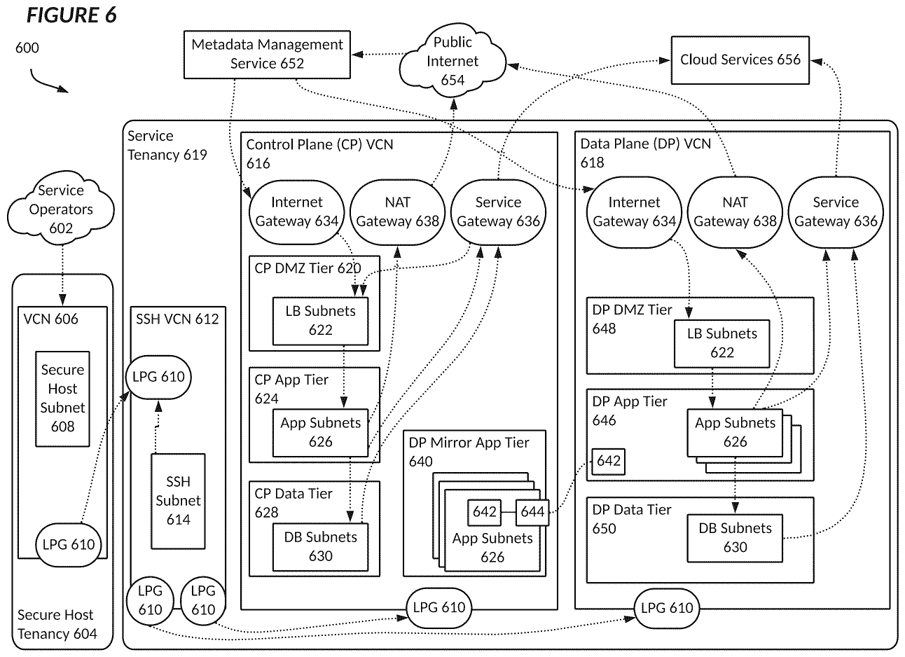

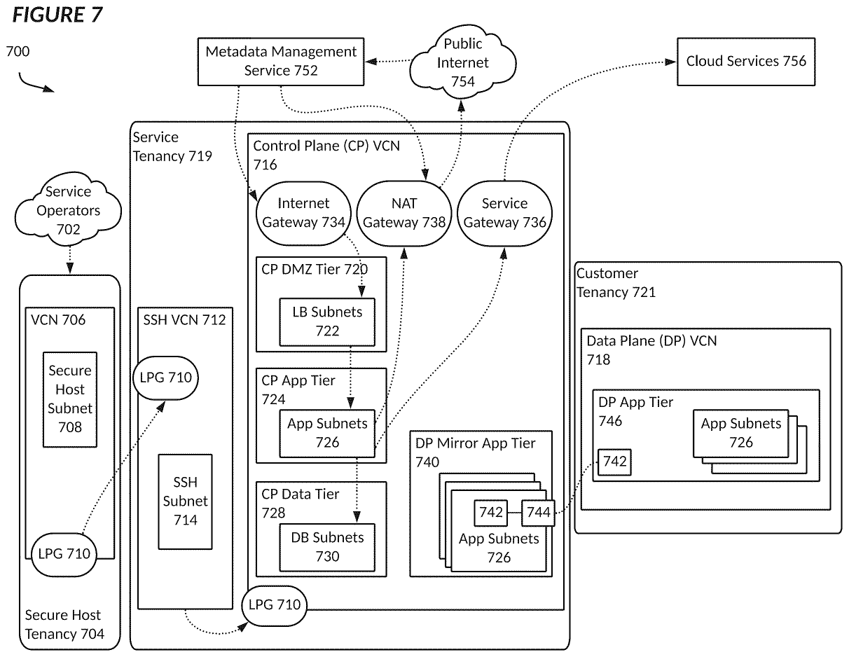

As detailed below regarding FIGS. 6-10, the cloud service 103 includes one or more services that are made available by a cloud services provider (CSP) to users, tenants, or customers on demand using systems and infrastructure provided by the CSP. For example, the cloud service 103 may include components, such as database services, storage services, and compute services, hosted on physical devices, such as servers, storage systems, and network devices within the datacenter 105.

The datacenter 105 is a component of a CSPI that houses computational, storage, and networking services. The datacenter 105 includes physical computing devices 107 (e.g., servers, routers, switches, storage arrays) communicatively coupled via a network 119, such as a local area network (LAN) that supports virtualized computing environments, on-demand hardware services, or other distributed computing architectures. Additionally, the datacenter 105 may implement one or more resource orchestration layers, hypervisors, containerization frameworks, or other software-defined infrastructure to facilitate dynamic provisioning, scaling, or isolating computing workloads.

The computing devices 107 are physical data processing devices or systems, including software and hardware, that provide computer resources (e.g., processing resources, memory resources, storage resources, network resources, etc.) for computing activities such as executing workloads. Example physical computing devices 107 include servers, racks, personal computing devices, network active gear, network passive gear, storage devices, edge computing devices, and various other devices. Example servers include graphics processing unit (GPU) servers, AI servers, central processing unit (CPU) servers, storage servers, and various other devices. In some embodiments, the computing devices 107 are worker nodes managed by a Kubernetes platform, wherein the individual worker nodes provide computer resources for executing workloads. The worker nodes may host one or more pods, wherein individual pods include one or more containers.

The cloud resources 109 are units of compute, storage, network, or service capacity available to users via the cloud service 103. An individual cloud resource 109 may correspond to a virtual or physical asset that includes any of the following: a VM, a container, a bare metal instance, storage units, virtual networks, firewalls, load balancers, and platform-level services (e.g., databases, analytics engines, machine learning (ML) endpoints). For example, the cloud resource 109 may be associated with a server that is mounted in a particular rack located in a particular aisle of a room within the datacenter 105.

The protection mechanisms 111 include physical devices that, individually and in combination, deliver protection capabilities for monitoring and securing infrastructure of the datacenter 105. Example protection mechanisms 111 include access control devices, surveillance devices, environmental monitoring devices, and other such devices. Example access control devices systems include locking mechanisms, barriers, cages, security gates, mantrap entry systems, biometric authentication systems, radio frequency identification (RFID) and smart card readers, password-based authentication systems, and similar devices. Example surveillance devices include video cameras, motion sensors, radio-frequency sensors, imaging cameras, laser tripwire systems, alarms, audio surveillance systems, and similar devices. Example environment monitoring devices include fire sensors, smoke sensors, temperature sensors, water detection sensors, humidity sensors, and similar devices.

The cloud management system 113 includes hardware, software, or a combination thereof that selects, initiates, and terminates cloud resources 109 on the computing devices 107 based on the protection level afforded by the protection mechanisms 111. Additionally, the cloud management system 113 selects and manages the protection mechanisms 111 to monitor physical access, detect environmental anomalies, and enforce access control policies. For example, based on state information obtained from the protection mechanisms 111, the cloud management system 113 determines if a particular computing device 107 affords a protection level that satisfies protection criteria of a requested cloud resource 109. Responsive to determining that the protection level satisfies the protection criteria, the cloud management system 113 initiates the execution or storage of the requested cloud resource on the computing device 107. Responsive to determining that the protection level does not satisfy the protection criteria, the cloud management system 113 prevents, terminates, or transfers the execution or storage of the requested cloud resource on the computing device 107.

In some embodiments, the cloud management system 113 comprises a Kubernetes cluster configured to orchestrate deploying, scheduling, and terminating worker nodes, wherein the individual worker nodes include one or more of the computing devices 107. The Kubernetes platform also monitors operational and protection state information of the worker nodes, including performance metrics, network connectivity, and physical protection afforded to the computing devices 107 by the protection mechanisms 111. Additionally, the Kubernetes platform may configure a Kubernetes cluster to select a worker node executed on computing devices 107 that meets protection requirements for provisioning a requested cloud resource 109.

The AI model 115 includes natural language models, such as a large language model (LLM) capable of transforming natural language descriptions of protection requirements into structured protection criteria corresponding to predefined protection dimensions. In some embodiments, the AI model is a custom model trained to determine one or more target protection levels or target protection corresponding to the target protection levels. For example, the AI model may be trained on domain-specific training data, including protection policies, compliance standards, provisioning rules, and historical provisioning requests labeled with corresponding protection policies, levels, and/or criteria. In some other embodiments, the AI model is a third-party or commercially available general-purpose language model adapted for use in generating the target protection criteria. In such cases, the cloud management system 113 may formulate prompts for the AI model 115 to classify a user's natural language input according to preestablished protection levels constrained by the protection policies, compliance standards, and provisioning rules.

The communication links 117 include wired and/or wireless information communication channels, such as the Internet, an intranet, an Ethernet network, a wireline network, a wireless network, a mobile communications network, and/or another communication network. For example, the client device 101 may communicate with the cloud service 103 via the Internet by exchanging data packets through a Wi-Fi or cellular data network connection.

In a non-limiting example, the cloud management system 113 receives a request for provisioning a cloud resource 109 from a tenant of the cloud service 103 via the client device 101. The example request includes a natural language statement that indicates desired protection requirements of the tenant for the cloud resource. In one example, the request is also associated with metadata, such as tenant identifier (e.g., Tenant_Alpha) and computing requirements for the cloud resource. The example natural language statement indicates, “The workload must be physically isolated and network isolated from other workloads and tenants. The physical isolation must be monitored and auditable. Tenant requires exclusive access to the physical system once per week.” The cloud management system 113 transforms the user requirements into a prompt for the AI model. For example, the system generates a structured prompt that includes metadata, protection parameters, and response constraints associated with the request. For example, the system may generate the following formatted prompt: [tenant_id: Tenant_Alpha; resource_type: compute; input: “The workload must be physically isolated and network isolated from other workloads and tenants. The physical isolation must be monitored and auditable. Tenant requires exclusive access to the physical system once per week”; access_control_level: 1-5, surveillance_level: 1-5, environmental_monitoring_level: 1-5]. The cloud management system 113 submits the prompt submitted to the AI model. Responsive to the prompt, the AI model may output the following target protection levels: [access_control_level: 5; surveillance_level: 5; environmental_ monitoring_level: 4; access_rules: weekly].

The cloud management system 113 maps the protection levels to target protection criteria. Some embodiments perform the mapping in accordance with a protection policy established by the tenant and/or required by the datacenter 105. For example, access control level 5 may correspond to a set of target protection criteria that require the protection mechanisms 111 corresponding to the following: keycard and biometric authentication (e.g., facial recognition and fingerprint scanning) for individual entry points at all physical levels of the datacenter, including building entrance, server rooms, and individual server racks; and logging of all physical access events with identity verification tied to authorized personnel from the tenant. Surveillance Level 5 may correspond to a set of target protection criteria requiring protection mechanisms 111 that correspond to the following: continuous video surveillance at all datacenter levels, including external entry points, server rooms, and rack-level enclosures; real-time facial recognition for all personnel entering the premises; and storing surveillance logs for a minimum retention period of 6 months in an immutable format. Environmental monitoring level 4 may correspond to a set of target protection criteria requiring protection mechanisms 111 that correspond to the following: real-time monitoring and alerting of environmental conditions, including temperature, smoke, power, and humidity, at room and rack levels; logging of all environmental sensor readings, with automatic correlation to operational anomalies; and immediate fault response protocols triggered by threshold violations.

The cloud management system 113 selects a candidate device from available computing devices based on the target protection levels and/or target protection criteria. The available computing devices may be a subset of the computing devices 107 that meet computing requirements that correspond to the request. Responsive to identifying a candidate computing device that satisfies the protection levels and/or target protection criteria, the system initiates provisioning of the cloud resource on the selected computing device. In doing so, the system ensures compliance with the tenant's desired protection requirements without requiring the tenant to specify protection criteria based on knowledge of the datacenter's 105 infrastructure and protection mechanisms 111.

### 4. Cloud Management System

FIG. 1B illustrates an example of the cloud management system 113, including hardware and software that perform processes and functions described herein. In one or more embodiments, the cloud management system 113 includes more or fewer components than the components illustrated in FIG. 1B. The components illustrated in FIG. 1B can be local to or remote from one another. The components illustrated in FIG. 1B can be implemented in software and/or hardware. Components can be distributed over multiple applications and/or machines. Multiple components can be combined into one application and/or machine. Operations described with respect to one component can instead be performed by another component.

One or more embodiments of the cloud management system 113 include a data repository 123, a computing device 127, and an interface 129. The data repository 123 includes any type of storage unit and/or device (e.g., a file system, database, collection of tables, or other storage mechanism) for storing data. Furthermore, the data repository 123 may include multiple different storage units and/or devices. The multiple different storage units and/or devices may or may not be of the same type or located at the same physical site. Furthermore, the data repository 123 can be implemented or executed on the same computing system as the cloud management system 113. Additionally, or alternatively, the data repository 123 may be implemented or executed on a computing system separate from the resource management system 121. The data repository 123 can be communicatively coupled, wired and/or wirelessly, to the cloud management system 113 via a direct connection or via a network.

One or more embodiments of the data repository 123 stores a device library 131, a resource library 133, a datacenter model 135, a datacenter map 137, a protection criteria database 139, and a policy database 141. Information describing the device library 131, the resource library 133, the datacenter model 135, the datacenter map 137, a protection criteria database 139, and a policy database 141 may be implemented across any of the components within the architecture 100. However, this information is illustrated within the data repository 123 for purposes of clarity and explanation.

The device library 131 is one or more logical data structures that store information of physical devices installed in the datacenter 105, including the computing devices 107 and the protection mechanisms 111. Information maintained by the device library 131 for individual devices may include one or more of the following: a device identifier, a physical location, an operational state, and a protection state. The information may also include or link to configuration files, event logs, surveillance logs, and historical data. The operational states indicate a device's health status or functional condition. Operational states include active, inactive, powered, initializing, paused, failed, and the like. For example, a temperature sensor in a server rack may output a signal indicating its operation state is active. The protection states indicate whether a fault, alert, or other protection event has been detected by a protection mechanism. The protection state may be obtained or derived from diagnostic signals, sensor outputs, control signals, or system logs generated by the protection mechanisms 111. In some embodiments, the protection states are obtained from a Kubernetes platform. The protection states may include a qualitative value (e.g., normal, warning, or faulted), a quantitative value (e.g., 0.00 to 1.00) indicating severity of the state, and metadata describing the event, fault, or alert. For example, the temperature sensor may output a signal indicating a binary value, such as “0” (e.g., pass) and “1” (e.g., fail), a qualitative value, such low, medium, high, and/or a quantitative value, such as “85 degrees” or “180 degrees.”

The resource library 133 is one or more logical data structures that store information identifying cloud resources 109 provisioned in the datacenter 105 or available for provisioning. The resource library 133 includes records that describe the characteristics, statuses, and associations of the cloud resources 109. Individual records in the resource library 133 may include metadata identifying the resource, the resource type, the hypervisors, and the owner, customer, or tenant. Additionally, the resource library 133 can store computational parameters, protection parameters, current operational state (e.g., active, inactive, initializing, paused, suspended, failed, terminated), and an allocated computing device 107.

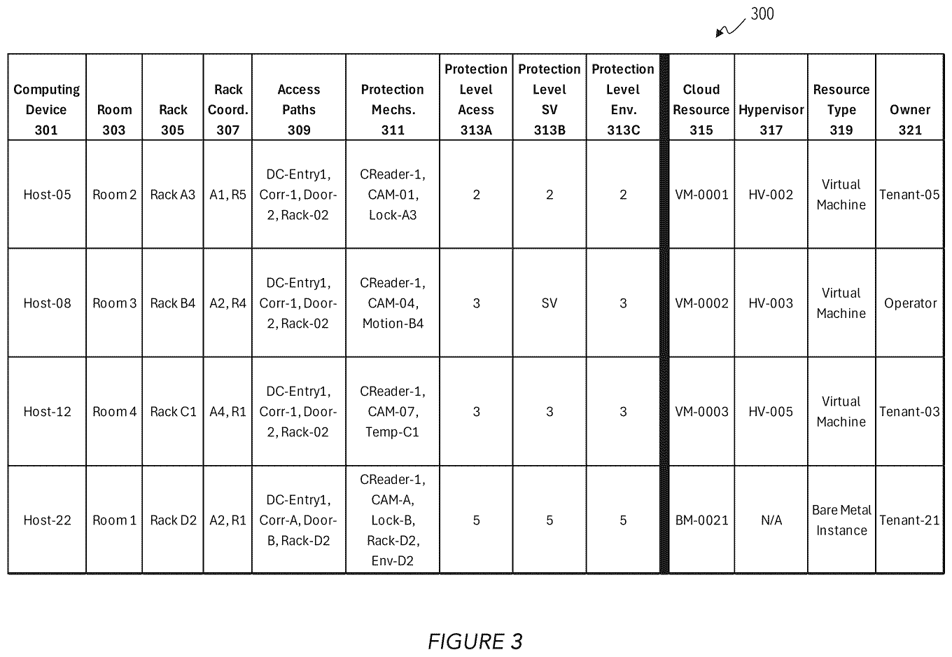

The datacenter model 135 includes one or more logical data structures that store information identifying relationships between the physical topology of the datacenter 105 and the physical locations of computing devices 107, cloud resources 109, and protection mechanisms 111 deployed within the datacenter 105. The datacenter model 135 may be implemented using structured tables, relational schemas, key-value associations, or other data representations of relationships. For example, FIG. 3 illustrates a tabular data structure 300 including records of an example of the datacenter model 135. It is understood that other types of data structures, such as data graphs, can be used for the datacenter model 135.

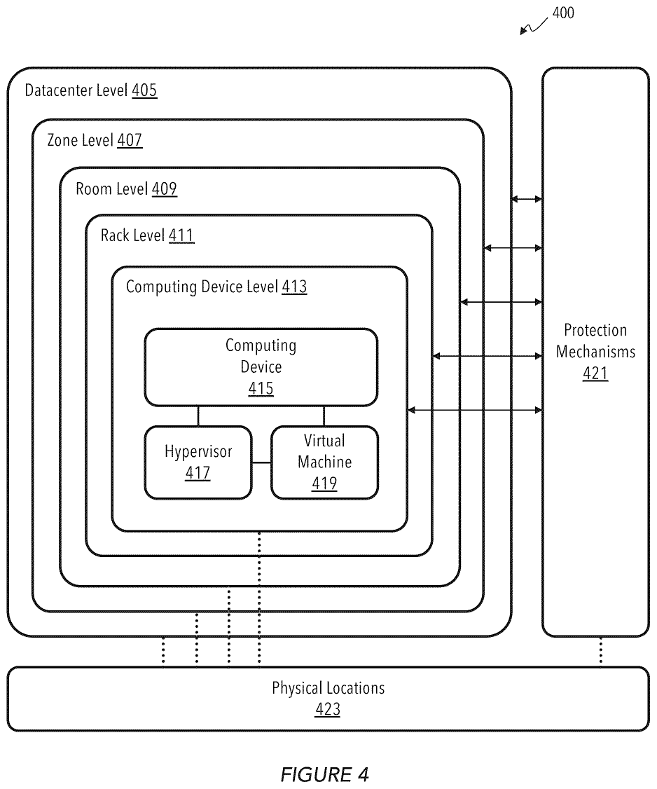

One or more embodiments of the datacenter model 135 represent mappings between the hierarchical logical levels of the datacenter 105, physical devices, and physical locations of the device in the datacenter 105. For example, referring to the infrastructure model 400 illustrated in FIG. 4, the datacenter model 135 may associate a VM instance 419 with a hypervisor 417 and associate the hypervisor 417 with a corresponding physical computing device 415 in a computing device level 413. Additionally, the infrastructure model 400 may associate the computing device 415 with a rack in a rack level 411, the rack with a room in a room level 409, the room with one or more zones in a zone level 407, and the zone with the datacenter facility in a datacenter level 405. Furthermore, the individual logical levels in the hierarchy are linked to a respective physical location 423 and associated one or more protection mechanisms 421.

In addition, the datacenter model 135 stores associations between computing devices 107 and corresponding protection mechanisms 111. The associations may be derived from the physical locations of the protection mechanisms 111 located relative to physical paths for accessing the computing devices 107. For instance, the datacenter model 135 may store access paths that a user may traverse to access a computing device 107 and a subset of protection mechanisms 111 corresponding to the access paths. An example subset of protection mechanisms may include access control mechanisms at entry points, biometric or badge scanners in adjacent corridors, surveillance cameras monitoring interior rooms or aisles, and environmental or intrusion sensors installed near the rack.

Embodiments of the datacenter model 135 further associate individual computing devices 107 with one or more protection levels that represent the level of physical protection afforded to that device across multiple protection dimensions by the protection mechanisms 111. For example, the protection level may be a discrete value in a predefined range (e.g., 1 to 5) representing a protection level or dimension (e.g., Level 1 to Level 5). The individual protection levels may be associated with respective sets of protection criteria. For example, a tenant's security policy may map a protection level for the individual dimensions to a corresponding set of protection criteria.

The datacenter map 137 includes one or more data structures that represent the datacenter's 105 physical layout. The layout may be represented as a graph, matrix, or coordinate-based structure that represents the arrangement of the physical infrastructure within the datacenter 105. For example, the datacenter map 137 includes information representing relationships among structural components, such as walls, partitions, and equipment rows.

Additionally, the datacenter map 137 includes information encoding representations of physical features, including doors, corridors, rooms, aisles, rows, and rack locations. Furthermore, the datacenter map 137 includes information encoding directional movement constraints for routes of travel between locations within the datacenter 105. Some embodiments store pre-established travel routes that represent access paths between entry points and rack locations.

The protection criteria database 139 includes one or more data structures storing protection criteria. As used herein, “protection criteria” refer to structured, machine-readable data, such as attribute-value pairs, that specify capabilities corresponding to protection levels.

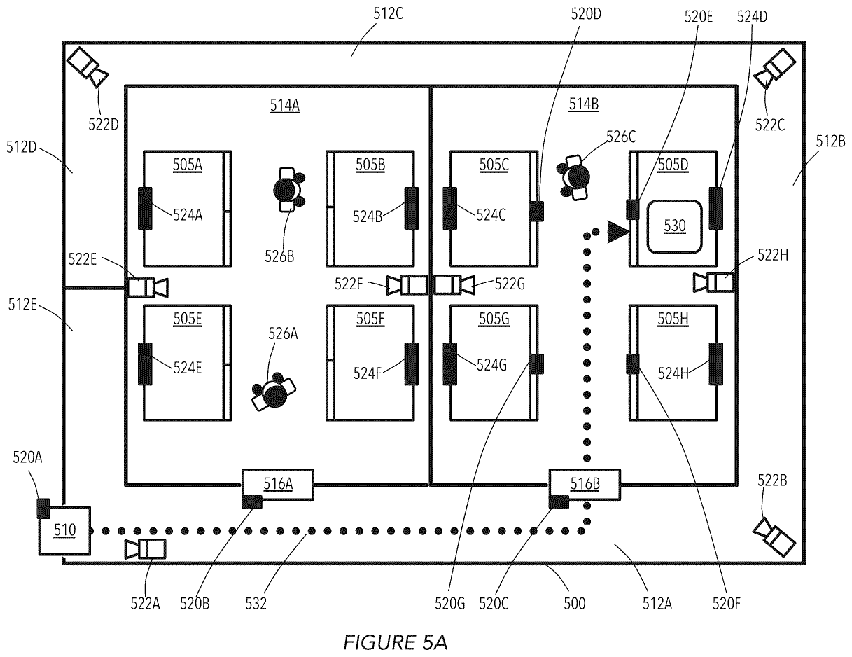

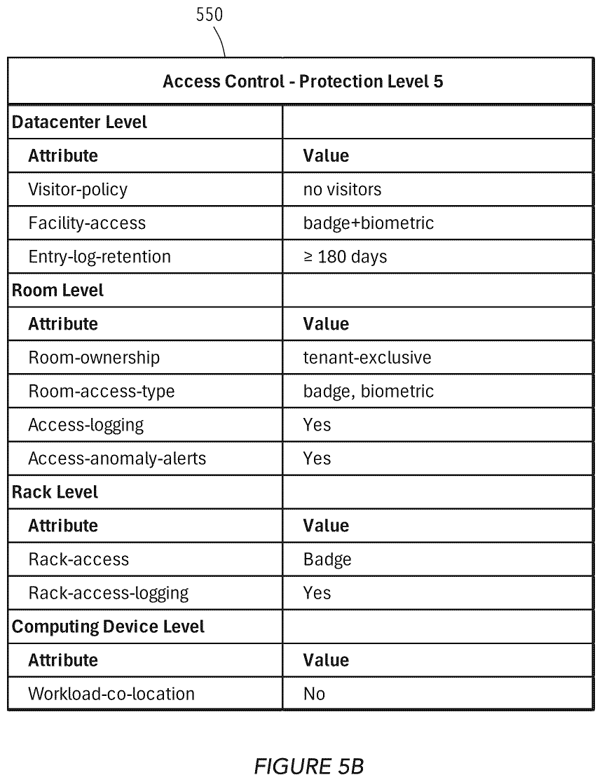

For example, FIG. 5C illustrates an example set of protection criteria associated with Protection Level 5 for the access control dimension. The protection criteria database 139 may store sets of current protection criteria in association with metadata identifying the request that the parameters were derived from, such as a tenant identifier, resource type, timestamp, and originating client device. Additionally, the protection criteria database 139 may store sets of criteria protection criteria corresponding to the capabilities of the computing devices 107.

The policy database 141 comprises one or more data structures that store associations between protection policies defined by individual tenants or by an operator of a datacenter, protection levels corresponding to the policies, and sets of protection criteria corresponding to the protection levels. As used herein, a “protection policy” refers to a set of rules, preferences, or compliance requirements that define how protection levels are to be interpreted and enforced for a given tenant or operator. The protection criteria may include, for example, specific requirements for access control, surveillance, environmental monitoring, and isolation. The policy database 141 may include relational tables or graph-based data structures. In some embodiments, policies of different tenants may assign different protection criteria to the same protection level. For example, Protection Level 4 for access control may correspond, under a first tenant's policy, to requiring biometric entry and badge authentication at the room level, while under a second tenant's policy, the same level may require biometric entry and badge authentication at both the room and rack levels.

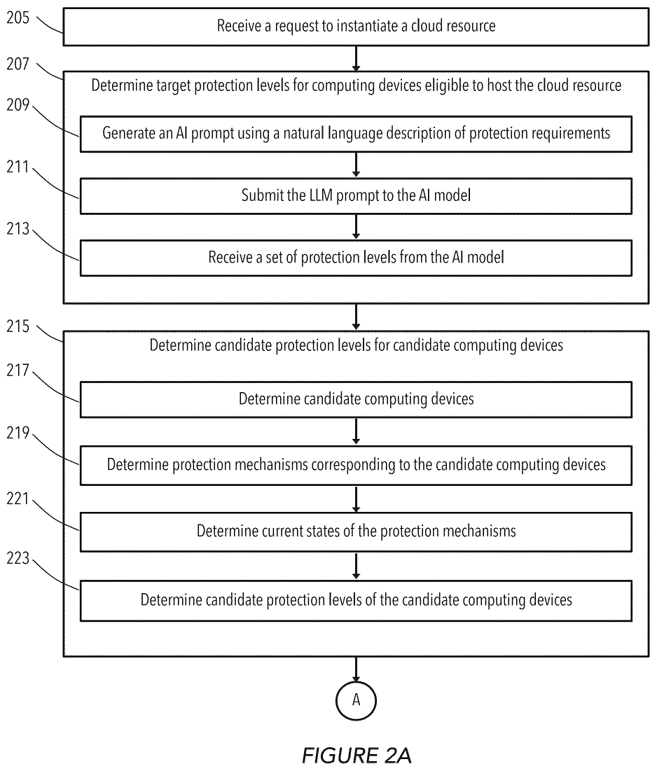

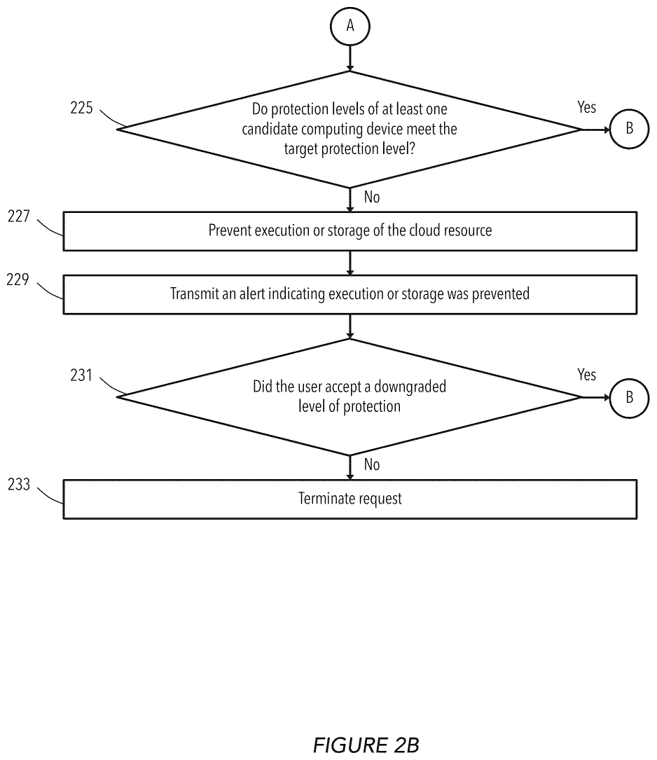

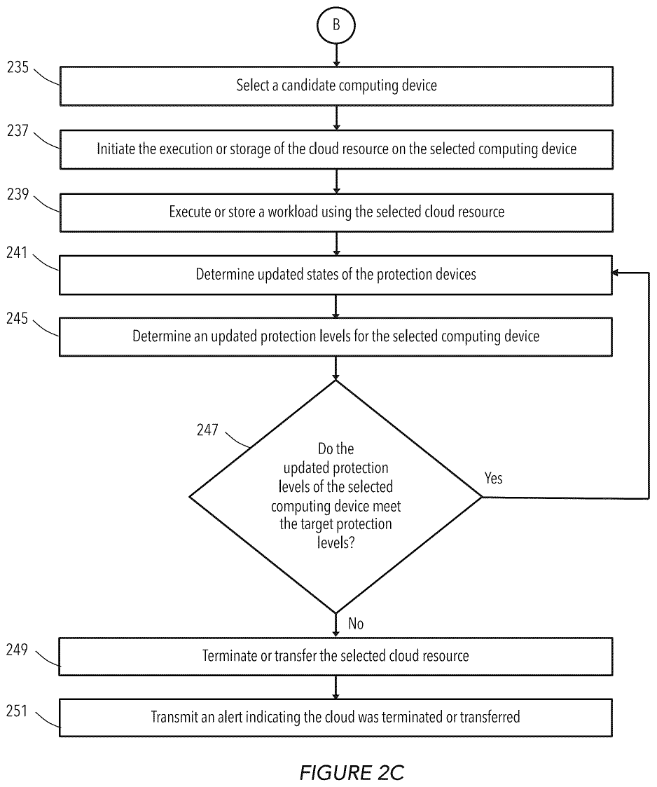

One or more embodiments of the computing device 127 include hardware and/or software configured to perform operations described herein. Example operations are described below with reference to FIGS. 2A, 2B, and 2C. The computing device 127 executes non-transitory computer-readable program instructions, such as an operating system and application programs, that are stored in memory devices and/or a storage system. Additionally, the computing device 127 executes program instructions of a protection management module 151, a resource management module 153, a monitoring module 155, and an AI interface module 157.

The protection management module 151 manages the protection mechanisms 111 within the datacenter 105. Managing the protection mechanisms 111 includes installing and configuring the protection mechanisms 111. Installation may include registering a protection mechanism 111 with the device library 131 and/or the datacenter model 135. Configuring includes establishing access rules, operational schedules, and threshold parameters for a protection mechanism 111 to trigger alerts, events, or faults. For example, access rules define the individuals or entities authorized to access specific locations of the datacenter 105 and schedules for the access. The access rules may be defined based on policies of the user or cloud service provider for user authentication, assigned roles, security clearances, temporal requirements, environmental conditions, or other contextual parameters. Additionally, or alternatively, the protection management module 151 may implement access rules output by the AI model 115 derived from the user's requests.

The resource management module 153 controls the selection and provisioning of the cloud resources 109. As detailed below, the resource management module 153 selects one or more of the computing devices 107 for instantiating or placing one or more of the cloud resources 109 based on the current protection level afforded to the computing device 107. Additionally, the resource management module 153 controls the provisioning of a cloud resource 109 based on other criteria, such as hardware requirements, resource utilization, service agreements, and policy constraints.

The monitoring module 155 collects, aggregates, and processes operational data from computing, storage, and network infrastructure components. The monitoring module 155 may interact with one or more agents, collectors, and backend services to continuously or periodically receive status information from the computing devices 107, protection mechanisms 111, and other infrastructure of the datacenter 105. The status information may include health metrics, event logs, and alerts. The monitoring module 155 logs the status information in the device library 131 and the resource library 133 as time-indexed records. Additionally, the monitoring module 155 generates and maintains the datacenter model 135. Generating the datacenter model 135 includes obtaining device information from the device library 131, resource library 133, the protection management module 151, and/or the resource management module 153 to populate records the datacenter model 135 such as illustrated in FIG. 3.

The AI interface module 157 interacts with the AI model 115 to determine target protection levels for candidate computing devices 107 eligible to host a cloud resource 109 in response to a provisioning request. The AI interface module 157 processes protection requirements included in a natural-language request to derive prompt parameters and response constraints for generating a prompt for the AI model 115. The AI interface module 157 transmits the prompt to the AI model 115 and receives, in response, a set of target protection levels and/or criteria corresponding to protection dimensions. In some embodiments, the AI interface module 157 may apply transformation templates that convert the text of the request into a prompt. Additionally, or alternatively, the AI interface module 157 parses the natural language input to identify semantic elements that indicate protection parameters associated with the protection dimensions or policies defining sets of target protection criteria for the protection dimensions. The AI interface module 157 may apply named-entity recognition, semantic role labeling, and dependency analysis to extract elements associated with security intents, assets, constraints, and temporal expressions. From the elements, the AI interface module 157 determines protection parameters, corresponding to the protection dimensions, and defines response constraints specifying that each dimension be assigned a protection level (e.g., a range from 1 to 5).

The interface 129 includes hardware and/or software configured to facilitate communications between a user and the cloud management system 113. The interface 129 renders user interface elements and receives input via user interface elements. Examples of interfaces include a GUI, a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In an embodiment, different components of interface 129 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the interface 129 is specified in one or more other languages, such as Java, C, or C++.

### 5. Provisioning Cloud Resources on Computing Devices Based on Natural Language Descriptions

FIGS. 2A, 2B, and 2C illustrate an example set of operations for provisioning cloud resources in accordance with one or more embodiments. One or more operations illustrated in FIGS. 2A, 2B, and 2C may be modified, rearranged, or omitted. Accordingly, the particular sequence of operations illustrated in FIGS. 2A, 2B, and 2C should not be construed as limiting the scope of one or more embodiments.

A system receives a request to instantiate a cloud resource (Operation 205). The system may receive the request from a user via an interactive GUI presented at a client computing device. The request may include information for provisioning the cloud resource, such as an identification of the requestor (e.g., a cloud service, user, customer, tenant or operator), the requested cloud resource, and computing parameters for the cloud resource (e.g., compute, memory, storage, input/output, and network requirements). Additionally, the request includes a natural language description of desired protection requirements for the cloud resource. The protection requirements may correspond to one or more pre-established protection dimensions, such as access control, surveillance, environmental monitoring, and isolation. The description may also include other parameters, such as temporal characteristics that indicate access rules for one or more physical computing devices that host the requested cloud resource. For example, the request may state, “The resource must be isolated from resources of other tenants. Workloads must be protected from unaudited execution. The tenant's personnel must have exclusive access to the room containing the computing resource every Wednesday afternoon.” It is understood that prompts may be more or less specific than the instant example. For example, the request may more specifically state, “The workloads must be protected from running on a server rack that has weak protection for the top-of rack (TOR) switch.”

The system determines target protection levels for computing devices that are eligible to host the cloud resource (Operation 207). One or more embodiments determine a set of protection levels of the computing devices based on the protection requirements in the request. The individual protection levels may represent a score and/or weight corresponding to the individual protection dimensions. For example, a protection level for the access control dimension may be categorized into one of five levels, Level 1 to Level 5, wherein Level 1 is the lowest score or weight and Level 5 is the highest score or weight.

In some non-limiting examples, Level 1 for the access control dimension may correspond to a facility with unsecured physical entry points or mechanical locks using common keys; Level 2 may correspond to keycard-based entry without logging of entry and exit events; Level 3 may correspond to keycard-based entry with logging of entry and exit events; Level 4 may correspond to multi-factor authentication (e.g., keycard and PIN) with centralized logging and access policy enforcement; and Level 5 may correspond to biometric authentication combined with multi-factor credentials, continuous access auditing, and automated lockout in response to policy violations.

Level 1 for the surveillance dimension may correspond to no active surveillance; Level 2 may correspond to motion-activated cameras covering primary ingress points; Level 3 may correspond to continuous camera coverage of ingress and egress points with retention of recorded footage for a predetermined period; Level 4 may correspond to continuous multi-camera coverage of ingress, egress, and interior zones with real-time monitoring; and Level 5 may correspond to a fully redundant camera system with full-site coverage, automated object recognition, anomaly detection, and immutable offsite archival of all surveillance footage.

Level 1 for the environmental monitoring dimension may correspond to no automated environmental sensors; Level 2 may correspond to basic temperature monitoring; Level 3 may correspond to temperature and humidity monitoring with periodic data collection; Level 4 may correspond to real-time monitoring of temperature, humidity, particulate, and water ingress conditions with automated alerting; and Level 5 may correspond to redundant multi-sensor systems that incorporate predictive failure analytics, automated environmental control adjustments, and continuous offsite replication of environmental condition data.

Level 1 for the isolation dimension may correspond to workloads executing on a shared physical server without workload separation other than process boundaries; Level 2 may correspond to workloads separated into individual containers within a shared operating system instance; Level 3 may correspond to workloads executed on separate virtual machines with dedicated memory and virtualized I/O paths; Level 4 may correspond to workloads executed on physically separate servers within a shared data center rack; and Level 5 may correspond to workloads executed on physically separate servers in independent racks with dedicated power distribution, network paths, and controlled air handling zones.

The individual protection levels are associated with respective sets of protection criteria. The protection criteria may be represented as attribute-value pairs that are associated with a hierarchal level of the datacenter infrastructure. For example, as illustrated in FIG. 5C, Access Control-Protection Level 5 associates attribute-value pairs with a data center level, a room level, a rack level, and a computing device level that correspond to the hierarchical levels of the datacenter infrastructure illustrated in FIG. 4. Some protection levels (e.g., Level 5) may include attribute-value pairs that correspond to the hierarchical levels of the infrastructure, while other protection levels (e.g., Level 1) may include attribute-value pairs corresponding to a few or a single level (e.g., datacenter level 405).

It is understood that the system is not limited to the example protection dimensions, levels, and criteria described above. One or more embodiments may include additional protection dimensions, levels, and criteria that include more granular dimensions, levels, and criteria corresponding to, for example, different tenants, regulations, or infrastructures. The system may define additional protection levels above or below the examples previously described or may implement sub-levels within the individual levels. For instance, Protection Level 3 may be subdivided into Levels 3A, 3B, and 3C, each reflecting incremental enhancements in monitoring, access auditing, or system redundancy. These additional levels, or sub-levels, may be predefined or may be specified dynamically by an operator or a tenant. Additionally, some embodiments of the system generate a dashboard or other user interface that allows a user to manually create and edit the protection level and criteria.

One or more embodiments determine the target protection levels by generating an AI prompt based on the natural language description of the protection requirements (Operation 209). The prompt may incorporate pre-defined templates, context cues, or structured metadata to guide the AI model's response. For example, the system may convert the natural language description into a prompt including elements such as [Interpret the following statement and output a JSON object assigning a protection level (0-5) for the following categories: access control, physical surveillance, environmental monitoring, network isolation, and tamper detection. Statement: “The workload must be physically isolated in a room dedicated to the tenant and network isolated from other workloads and tenants. The physical isolation must be monitored and auditable. Tenant requires exclusive access to the room and the physical system during the hours of 9:00 a.m. to 6:00 p.m.”] Some embodiments derive the elements from the text using predefined keywords and templates. Additionally, or alternatively, some embodiments apply one or more semantic analysis techniques, such as keyword identification, named-entity recognition, semantic role labeling, and dependency analysis, to derive elements associated with security intents, assets, constraints, and temporal expressions. Furthermore, the system may define constraints for the output of the AI model that specify dimensions and protection levels. Furthermore, in some embodiments, the system may append system-specific instructions to the AI prompt, including definitions for a protection category, additional metadata about the resource and the request, and/or temporal requirements.

Determining the target protection levels may also include submitting the prompt to the AI model (Operation 211). The AI model may be a custom model trained to interpret security-related intents or a general-purpose third-party language model adapted for use with the system. For example, the AI model may be configured to process the natural language input and generate an output that represents protection levels and access rules consistent with the given output constraints, request metadata, and policies.

Determining the target protection levels may further include receiving, from the AI model, a set of protection levels corresponding to the protection dimensions for the received request (Operation 213). In some embodiments, the AI outputs a protection policy that corresponds to the set of protection levels. The individual protection levels may correspond to sets of target protection criteria for respective protection dimensions. For example, FIG. 5B illustrates a tabular data structure 550 that represents an example set of protection criteria for the access control-protection level 5. In some embodiment, the data structure 550 is associated with a protection policy of a particular tenant or operator.

The system determines candidate protection levels for candidate computing devices (Operation 215). To determine the candidate protection levels, the system evaluates the types, states, and locations of protection mechanisms that correspond to computing devices eligible and available to provision the requested cloud resource. In one or more embodiments, determining the candidate protection levels includes determining candidate computing devices available to execute or store the requested cloud resource (Operation 217). The system identifies the candidate computing devices based on parameters of the request. Identifying the candidate computing devices may include determining a set of computing devices in the datacenter that satisfy the computational parameters of the request. For example, the system may identify candidate computing devices that meet or exceed parameters for CPU, memory, storage, input/output capacity, and/or network capacity.

Determining the candidate protection levels may further include determining protection mechanisms that correspond to the candidate computing devices (Operation 219). One or more embodiments identify a subset of the protection mechanisms associated with the individual candidate computing devices by referencing a datacenter model. As described above and illustrated in FIG. 3, the datacenter model stores associations between the computing devices and corresponding subsets of the protection mechanisms located along respective access paths of the computing devices. Alternatively, the system identifies a subset of protection mechanisms associated with the individual candidate computing devices by identifying access paths using an electronic map that encodes constraints for travel routes between locations on the datacenter. Using the map, the system determines access paths from entry points to the computing device and identifies the protection mechanisms located in proximity to the identified access paths.

Additionally, determining the candidate protection levels includes determining current states of the protection mechanisms in the subsets (Operation 221). Determining the states of the protection mechanisms includes receiving or polling for information from the protection mechanisms to obtain events, alerts, and faults generated by the protection mechanisms. For example, a badge scanner located at a secure entrance may generate an event when a person accesses or exits a room. In another example, a power sensor may generate a fault when the power draw of a candidate computing device exceeds a threshold specified by the protection criteria. The protection mechanisms' states, including alerts or faults, may be logged along with contextual metadata. The logged states may be indexed by time and include a device identifier, a location, and a severity. For example, a logged alert may indicate the identity of individuals present in the room along with entry and exit times, related access control events, or recent workload deployments associated with nearby infrastructure.

Moreover, determining the candidate protection levels includes, for the individual candidate computing devices, determining a respective protection level (Operation 223). The system may categorize a candidate computing device into a protection level by determining if protection mechanisms associated with a candidate computing device satisfy the protection criteria corresponding to that level. For example, access control level 2 may include criteria that requires locks at the entrance of the datacenter, a room housing the computing device, and a rack including the computing device. The protection criteria may specify [facility access: keycard; room access: keypad; rack-access: biometric]. By comparing protection criteria to the access control devices included in an access path for the candidate computing device as recorded in the datacenter model, the system determines if the candidate computing device meets the protection level. The candidate computing devices may likewise be evaluated with sets of protection criteria corresponding the different protection levels to determine a current protection level afforded for the protection dimensions.

Proceeding to FIG. 2B, as indicated by off-page connector “A,” the system determines if the protection levels of at least one candidate computing device meets the target protection levels derived from the user's request (Operation 225). The system may compare the target protection criteria to the protection criteria corresponding to the protection levels of the candidate computing device and determine if the capabilities meets or exceeds the criteria. For example, the target protection level determined for the access control dimension of the request may require exclusive access to a computing resource by a tenant. If a candidate computing device's protection level allows the devices to reside in a shared server rack, then the system would determine that the candidate computing device does not meet the protection criteria for the request.

In another example, the system compares target protection criteria with the corresponding protection criteria of the candidate computing devices. For example, the access control protection level 4 protection criteria at the rack level may include attribute-value pairs such as [rack-access: keypad; access-logging: yes]. The system may determine if the subset of protection mechanisms associated with the candidate computing device at the rack level satisfies these attribute-value pairs. The system may repeat this evaluation for the individual hierarchical levels applicable to the protection levels for each of the protection dimensions being evaluated. If the candidate computing device satisfies the protection criteria across the applicable hierarchical levels, and if the corresponding protection mechanisms are operational, then the candidate computing device may be classified into Protection Level 4. If one or more of the protection criteria are not satisfied, the candidate computing device may instead be classified into a lower protection level such as Protection Level 3.

If the at least one of the candidate computing devices meets the target protection level, then the process proceeds to FIG. 2C, as indicated by off-page connector “B” described below. If none of the candidate computing devices meet the target protection criteria, then the system prevents execution or storage of the cloud resource (Operation 227). For example, the system may determine that the datacenter currently lacks any computing devices that are available, eligible, and meet criteria of Protection Level 5 in the access control dimension. The system may therefore decline to allocate any of the candidate computing devices to host the requested cloud resource.

Additionally, in combination with preventing execution, the system may transmit an alert indicating that execution or storage of the workload was prevented (Operation 229). The alert may be transmitted to a system administrator, tenant interface, compliance auditing service, or automated remediation system. The alert may include information identifying the failed protection level and/or criteria, including the protection scores of one or more evaluated candidate devices. Some embodiments of the system may include a prompt in the alert or in a separate message indicating the following: the level and/or specific protection criteria the candidate computing devices failed to meet, a description of those criteria, the definition of the next lowest protection level for the same dimension, and an option to apply the downgraded protection level. For example, for the access control dimension, Protection Level 5 may require that the tenant have exclusive access to a room containing the physical computing device and that the tenant have exclusive access to a secure cage containing the physical computing device. If the highest available candidate device supports Protection Level 4, the system may indicate that Level 4 provides exclusive access to a secure cage containing the physical computing device without exclusive access to the enclosing room. The prompt may be implemented as interactive HTML elements within the alert, such as radio buttons or selection fields, enabling the recipient to select one or more candidate devices and confirm acceptance of the downgraded protection level. In one non-limiting example, the system may display: “Protection Level 5 unavailable for Access Control: biometric-controlled room entry disabled. Highest available: Level 4—secure cage with exclusive access. Select a candidate device to proceed with Level 4.” In one or more embodiments, the system determines if a recipient of the alert or other message accepted a downgraded protection level (Operation 231). If not, the system terminates the request to instantiate the cloud resource (Operation 233). If so, the process proceeds to FIG. 2C, as indicated by off-page connector “B.”

Referring to FIG. 2C, in response to identifying one or more qualifying candidate computing devices that meet the target protection level, the system selects a candidate computing device (Operation 235). Some embodiments select a candidate computing based on the respective computational parameters and/or protection criteria of the devices. For example, the system may calculate weighted rankings of the qualifying computing devices based on, for example, computational capacity and resources, protection level, and cost. Based on the rankings, the system may select one or the qualifying candidate computing devices associated with the lowest computational resources, cost, and protection level that satisfy the parameters in relation to the qualifying candidate computing devices.

In some embodiments, a Kubernetes platform selects one or more worker nodes from among available worker nodes provisioned on candidate computing devices. Selecting a candidate computing device may include selecting a corresponding worker node capable of executing or storing a portion of the requested cloud resource. For example, the Kubernetes platform may select a first worker node provisioned on a storage server and a second worker node provisioned on a CPU server, wherein both represent a candidate computing device. The Kubernetes platform may then schedule respective portions of the workload to execute across the selected worker nodes in parallel.

The system initiates the execution or storage of the cloud resource in the selected computing device (Operation 237). Initiating includes assigning the selected computing device to the request and instantiating the cloud resource. Additionally, the system may store or update metadata of the assigned cloud resource in the resource library and/or datacenter model. For example, as illustrated in FIG. 3, the system may associate an identifier of the selected computing device with identifiers of the cloud resource, a hypervisor, a resource type, and the owner. The system executes or stores a workload using the selected cloud resource (Operation 239). Execution may include launching user-defined processes, initiating application-level services, or running batch or stream processing jobs according to the execution parameters specified in the workload request.

The system determines updated states of the protection mechanisms (Operation 241). The system continues to monitor and record current states of the protection mechanism, including the subset of protection mechanisms that correspond to the selected computing device along with contextual metadata. For example, via surveillance devices and access control devices, the system monitors the identities of individuals present in the access paths associated with the computing device. Additionally, via environmental sensors, the system monitors environmental conditions associated with the computing device.

The system determines an updated protection level for the selected computing device (Operation 245). The system determines the protection level of the selected computing devices based on the updated states of the protection mechanisms that correspond to the selected computing device. For example, based on the state, the system determines protection criteria and updates the current protection level. The system determines if the updated protection level of the selected computing device satisfies the target protection level of the request (Operation 247). If the updated protection level of the selected computing device satisfies the protection criteria, then the system iteratively returns to updating the states of the protection mechanisms and determining the updated protection level.

If the updated protection level of the selected computing device does not satisfy the target protection level, the system terminates or transfers execution of the selected cloud resource (Operation 249). In one example, the system may determine that the selected computing device has not met the protection level for a threshold period of time. For instance, a protection level may require that a rack containing a computing device executing a worker node selected for the cloud be visually surveilled 24 hours per day. If the system determines that a state of a camera surveilling rack the has been inactive for longer than one minute, then the system may terminate the execution of the cloud resource or transfer the cloud resource to another qualifying candidate computing device. In another example, the system may terminate or transfer the cloud resource immediately such as when an unauthorized user enters a secure room housing the worker node.

Additionally, in a Kubernetes platform, the system may determine that an insufficient number of worker nodes are available on candidate physical computing devices that satisfy a target protection level associated with a requested cloud resource. For example, a tenant may request deployment of a compute workload requiring Protection Level 5 for access control and surveillance. The system may identify a single physical computing device configured with biometric entry and redundant surveillance sufficient to meet Protection Level 5, whereas the requested workload requires at least three worker nodes for execution. In response, the system may select the one eligible worker node executing on the compliant computing device and further select two additional worker nodes executing on physical computing devices that partially satisfy the protection level such as devices configured to meet Protection Level 4 criteria. The Kubernetes platform may then instantiate portions of the workload across the selected set of worker nodes.

The system may also transmit an alert indicating that execution of the workload was terminated or transferred (Operation 251). The alert may include contextual information identifying the failed protection criteria and the updated protection level of the selected computing device. For example, the system may issue an alert for display by the dashboard indicating that an unauthorized person entered the room housing the cloud resource, the time of the event, and the person's identity. In response to the alert, the user may manually terminate the computing resource and trigger the system to programmatically transfer the cloud resource to another qualified computing device.

### 6. Example Embodiments

Detailed examples are described below for purposes of clarity. Components and/or operations described below should be understood as one specific example that may not be applicable to certain embodiments. Accordingly, components and/or operations described below should not be construed as limiting the scope of any of the claims.

FIG. 3 is a block diagram illustrating an example data structure 300 storing records of a datacenter model in accordance with one or more embodiments. The records of the example datacenter model identify relationships between computing devices, physical locations, access paths, protection mechanisms, and protection levels of the computing devices. Columns 301-313C of the data structure model 300 associate computing devices with respective rooms, racks, rack coordinates, access paths, protection mechanisms, and protection levels for multiple dimensions. The computing device column 301 identifies a hardware entity within the datacenter that is capable of hosting one or more provisioned cloud resources, such as a physical server or storage system. The room column 303 identifies the particular physical room or other enclosed area housing the computing device, such as a tenant-dedicated space, a shared room, or an isolated zone within the datacenter. The room column 305 identifies a rack containing the computing device and the rack coordinates column 307 identifies the position of the rack using a coordinate scheme that may include aisle identifiers, row numbers, and rack identifiers within a room. The access paths column 309 identifies one or more ordered sequences of physical and logical checkpoints, such as datacenter entrances, corridors, doors, access control systems, and secure racks, that authorized users physically traverse to access the computing device. The protection mechanisms column 311 identifies the set of physical and logical protection mechanisms associated with the computing devices based on the physical location and access paths of the computing devices. The protection level columns 313A-313C identify quantitative or categorical protection levels assigned to the computing devices based on the surrounding physical environments, applicable access control mechanisms, surveillance coverage, isolation guarantees, and compliance with regulatory or contractual protection requirements. the protection level column 313A-313C may correspond to respective protection dimensions. For example, column 313A corresponds to the access control dimension, column 313B corresponds to the surveillance dimension, and column 313C corresponds to the environmental monitoring dimension.

In one example, the datacenter model indicates that computing device Host-22 is located in Room 1 within Rack D2 having coordinates A2, R1 (e.g., Aisle 2 and Row 1). The datacenter model further indicates that Host-22 is associated with an access path in the datacenter that includes DC-Entry1, Corridor-A, Door-B, and Rack-D2, representing a physical route from the primary datacenter entrance through Corridor A, through access-controlled Door B, and to secured Rack D2. Additionally, the datacenter model identifies Host-22 as being associated with protection mechanisms C-Reader-1, CAM-A, Door-Lock-B, Rack-Lock-D2, and Env-D2 that respectively correspond to card reader 1, surveillance camera A, electronic door lock B, rack-specific locking mechanism D2, and environmental monitoring systems designated Env-D2.

Furthermore, the datacenter model classifies Host-22 as satisfying the requirements for Protection Level 5 for the access control, surveillance (SV), and environmental monitoring (ENV) dimensions.

Additionally, upon provisioning a cloud resource to a host computing device, the system updates the datacenter model to associate the cloud resource with the corresponding host computing device. The columns 315 through 321 of the example datacenter model record such associations by linking computing devices to cloud resources, virtualization infrastructure, resource classifications, and corresponding tenants or owners. The cloud resource column 315 identifies a provisioned logical resource instance hosted on the computing device, such as a VM, container, bare metal server instance, or any other form of cloud-exposed compute resource. The hypervisor column 317 identifies the virtualization layer or management software that is responsible for creating, controlling, or monitoring the cloud resource hosted on the computing device. The resource type column 319 identifies the operational classification of the cloud resource instance, such as “VM,” “container,” “bare metal,” “GPU-enabled instance,” or other predefined types associated with specific service level agreements or usage models. The owner column 321 identifies the account, tenant, organization, or other entity to which the cloud resource instance has been provisioned. For example, the datacenter model indicates that Host-22 is associated with a cloud resource identified as BM-21. The resource BM-21 is classified as a bare metal instance and is recorded as being owned by Tenant-21.

FIG. 4 is a block diagram illustrating a model 400 of multilevel mapping between hierarchical physical levels of a datacenter in accordance with one or more embodiments. As previously described, the datacenter model 400 associates the hierarchical levels 405-413 with protection mechanisms 421 and respective physical locations 423. In the present example, the levels include a datacenter level 405, a zone level 407, a room level 409, a rack level 411, and a computing device level 413. The computing device level 413 may associate a VM instance 419 with one or more of the protection mechanisms 421 at respective locations. Additionally, the infrastructure model 400 associates the computing device 415 with a rack at the rack level 411. Moreover, the infrastructure model 400 associates the rack with a room of the data center at the room level 409, a corridor leading to the room at the zone level 407, and an entry door to the datacenter at the datacenter level 405. The topological elements at levels 405, 407, 409, 411, and 413 may be associated with one or more of the protection mechanisms at a respective physical location 423 in the corresponding level.

FIG. 5A illustrates an infrastructure of an example datacenter 500 in accordance with one or more embodiments. In this example, a cloud service employing the datacenter 500 receives a request from a tenant to provision a VM for the deployment of a new workload to be provisioned in the datacenter 500. The request includes a set of parameters that specify requirements for the cloud resource. These parameters include computational parameters for a processor architecture, memory size, storage capacity, input/output capacity, and network configuration. Additionally, the request includes a natural language description of protection requirements for access control, surveillance coverage, environmental monitoring conditions, and data protection requirements, such as “The workload must be physically isolated in a room dedicated to the tenant and network isolated from other workloads and tenants. The physical isolation must be monitored and auditable. Tenant requires exclusive access to the room and the physical system during the hours of 9:00 a.m. to 6:00 p.m.”

In response to receiving the request, the system generates an AI prompt using the natural language input in the request. As described above, the system applies various semantic analysis techniques to derive paremeters and constraints for the AI prompt. In this example, the prompt includes: [tenant_id: Tenant_Alpha; resource_type: compute; input: “The workload must be physically isolated in a room dedicated to the tenant and network isolated from other workloads and tenants. The physical isolation must be monitored and auditable. Tenant requires exclusive access to the room and the physical system during the hours of 9:00 a.m. to 18:00”;access_control_level: 1-5, surveillance_level: 1-5, environmental_monitoring_level: 1-5].

The system submits the prompt submitted to the AI model. In some embodiments, the AI model returns the following example set of protection levels: [access_control_level: 5; surveillance_level: 5; environmental_monitoring_level: 4; access_rule: daily_0900_1800]. The target protection level determined by the AI model for the protection dimensions (e.g., access control, surveillance, and environmental monitoring) corresponds to respective sets of target protection criteria for the hierarchical level of the datacenter 500, as illustrated the model of the multilevel mapping in FIG. 4. In turn, the target protection criteria require a set of protection mechanisms located in the hierarchical levels of the datacenter 500. For example, the target protection criteria for access control level 5 may require protection mechanisms that provide full physical and logical isolation of the computing resource in a tenant-dedicated room with independent entry, access limited to a predefined set of authorized personnel, and continuous audiovisual and environmental surveillance throughout the protected area. FIG. 5C illustrates an example set attribute-value pairs representing target protection criteria corresponding to access control protection level 5.

Additionally, the system evaluates the parameters to determine a set of candidate computing devices that are eligible for provisioning the requested VM. The system identifies the candidate computing devices housed in racks 505A-505H by applying the computational requirements of the request as filters across a library of available computing devices. The device library may include metadata describing the resource capacity, performance metrics, location, and operational status of the computing devices within the datacenter 500.

For the individual candidate computing devices, the system identifies and analyzes a corresponding subset of protection mechanisms associated with that computing device. The example datacenter 500 includes various protection mechanisms located at different hierarchal levels of the datacenter infrastructure as illustrated in FIG. 4. The datacenter 500 includes a primary entrance 510, corridors 512A-512E, rooms 514A and 514B, and doors 516A and 516B. The protection mechanisms may include access control devices 520A-520G, surveillance devices 522A-522H, and environmental sensors 524A-524H. Additionally, users 526A, 526B, and 526C wearing RFID badges may reside in the datacenter 500. In the present example, the primary entrance 510 and corridors 512A-512E are categorized as being in the datacenter level 405; the rooms 514A and 514B and doors 516A and 516B are categorized as being in the room level 409; and the racks 505A-505H are categorized as being in the rack level 411. As such, the access control device 520A and surveillance devices 522A-522D are associated with the datacenter level 405. The access control devices 520B and 520C, surveillance devices 522E-522H, and badges of the users 526A-526C are associated with the room level 409. The access control devices 520D-520F and environmental sensors 524A-524H are associated with the rack level 411.

The server 530 is one of the candidate computing devices available and eligible to host the requested VM. The server 530 is housed in rack 505D within room 514B. The system determines a subset of the protection mechanisms associated with the server 530 based on an access path 532 corresponding to location of the server 530. As previously described, the system may retrieve information describing the subset of protection mechanisms for the server 530 from a datacenter model such as illustrated in FIG. 3. Alternatively, the system may use mapping techniques to determine the subset of protection mechanisms in proximity to an access path 532 for the server 530.

As illustrated in FIG. 5A, the subset of protection mechanisms for the server 530 includes access control device 520A, cameras 522A and 522B, access control device 520C, access control device 520E, and environmental sensors 524D. The system maps the physical locations of these protection mechanisms across hierarchical containment levels of the datacenter 500, such as datacenter level 405, room level 409, rack level 411, and device level 413, and evaluates if the protection configuration at each level satisfies the attribute-value pairs defined for Protection Level 5. Accordingly, at the room level 409, the system may verify that protection is enforced by access control device 520C and 520E with biometric validation, that entry logs are enabled and actively monitored, and that cameras 522G and 522H provide coverage with real-time recording and retention capabilities. At the rack level 411, the system may verify that a candidate server resides at rack 505D configured for exclusive access by an authorized user 526C of the requesting tenant, that the rack 505D is equipped with access control device 520E (e.g., key-coded locks), and that environmental sensors 524D include operational sensors for temperature, humidity, smoke, and power.

The system may determine if states of the protection mechanisms associated with server 530 satisfy the target protection criteria for the request. In this example, the system determines that the protection mechanisms 520A, 520E, 522A, 522B, 522G, 522H, 526B, 524D, and 526C are operating and not indicating any protection fault, alerts, or events. For example, the system may determine that logs generated by access control device 520C and cameras 522G and 522H only indicate the authorized user 526C currently in room 514B. Additionally, the system may determine that the badge of user 526C is authorized, and no badges of unauthorized users, such as users 526A and 526B, are located in the room 514B. Moreover, the system may determine that the access control devices 520C and 520E are locked and configured solely for access by specific users. Furthermore, the system may determine that the environmental sensors 524D are operational and reporting acceptable ranges. Also, the system configures the access control devices based on the access rules.

If the system determines that the server 530, in conjunction with the associated protection mechanisms and their states, satisfies the target protection criteria for the hierarchical levels associated with Protection Level 5, then the system may select the server 530 to provision the requested VM. Once selected, the system initiates the instantiation of the VM according to the parameters of the request. During the operation of the VM on the server 530, the system monitors the states of the protection mechanism and updates the protection level of the hosting server 530. If the protection level falls below Level 5, then the system terminates the execution of the VM. In response to the termination, the system may programmatically transfer the VM to a different server meeting the target protection level.

### 7. Examples of Cloud Infrastructure

As noted above, infrastructure as a service (IaaS) is one particular type of cloud computing. For IaaS, the infrastructure (CSPI) provided by a CSP can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create VMs, install operating systems (OSs) on each VM, deploy middleware, such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
cid1.<RESOURCE TYPE>.<REALM>.[REGION][.FUTURE USE].<UNIQUE ID>where,
cid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c4” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service VMs (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more VMs. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed are required to be first set up. In some instances, the provisioning can be done manually, a provisioning tool may be utilized to provision the resources, and/or deployment tools may be utilized to deploy the code once the infrastructure is provisioned.

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, that may be portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, by way of example, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 implemented in the SSH VCN 612. The SSH VCN 612 can include an SSH subnet 614, and the SSH VCN 612 can be communicatively coupled to a control plane VCN 616 via the LPG 610 implemented in the control plane VCN 616. Also, the SSH VCN 612 can be communicatively coupled to a data plane VCN 618 via an LPG 610. The control plane VCN 616 and the data plane VCN 618 can be implemented in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 640 (e.g., frontend DB subnet(s) and/or backend DB subnet(s)). The LB subnet(s) 622 in the control plane DMZ tier 620 can be communicatively coupled to the app subnet(s) 626 in the control plane app tier 624 and an Internet gateway 644 that can be implemented in the control plane VCN 616. The app subnet(s) 626 can be communicatively coupled to the DB subnet(s) 640 implemented in the control plane data tier 628 and a service gateway 646 and a network address translation (NAT) gateway 648. The control plane VCN 616 can include the service gateway 646 and the NAT gateway 648.

The control plane VCN 616 can include a data plane mirror app tier 640 that can include app subnet(s) 626. The app subnet(s) 626 implemented in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be implemented in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 644 of the data plane VCN 618. The app subnet(s) 626 can be communicatively coupled to the service gateway 646 of the data plane VCN 618 and the NAT gateway 648 of the data plane VCN 618. The data plane data tier 650 can also include the DB subnet(s) 640 that can be communicatively coupled to the app subnet(s) 626 of the data plane app tier 646.

The Internet gateway 644 of the control plane VCN 616 and of the data plane VCN 618 can be communicatively coupled to a metadata management service 652 that can be communicatively coupled to public Internet 654. Public Internet 654 can be communicatively coupled to the NAT gateway 648 of the control plane VCN 616 and of the data plane VCN 618. The service gateway 646 of the control plane VCN 616 and of the data plane VCN 618 can be communicatively couple to cloud services 656.

In some examples, the service gateway 646 of the control plane VCN 616 or of the data plane VCN 618 can make application programming interface (API) calls to cloud services 656 without going through public Internet 654. The API calls to cloud services 656 from the service gateway 646 can be one-way; the service gateway 646 can make API calls to cloud services 656, and cloud services 656 can send requested data to the service gateway 646.

However, cloud services 656 may not initiate API calls to the service gateway 646.

In some examples, the secure host tenancy 604 can be directly connected to the service tenancy 619. The service tenancy 619 may otherwise be isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision resources. Resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be implemented in the data plane mirror app tier 640 and the data plane app tier 646.

In some examples, users or customers, of the system, can make requests, for example create, read, update, or delete (CRUD) operations, through public Internet 654 that can communicate the requests to the metadata management service 652. The metadata management service 652 can communicate the request to the control plane VCN 616 through the Internet gateway 644. The request can be received by the LB subnet(s) 622 implemented in the control plane DMZ tier 620. The LB subnet(s) 622 may determine that the request is valid, and in response, the LB subnet(s) 622 can transmit the request to app subnet(s) 626 implemented in the control plane app tier 624. If the request is validated and requires a call to public Internet 654, the call to public Internet 654 may be transmitted to the NAT gateway 648 that can make the call to public Internet 654. Metadata to be stored by the request can be stored in the DB subnet(s) 640.

In some examples, the data plane mirror app tier 640 can facilitate direct communication between the control plane VCN 616 and the data plane VCN 618. For example, changes, updates, or other suitable modifications to a configuration may need to be applied to the resources implemented in the data plane VCN 618. Via a VNIC 642, the control plane VCN 616 can directly communicate with, and can thereby execute the changes, updates, or other suitable modifications to configuration to, resources implemented in the data plane VCN 618.

In some embodiments, the control plane VCN 616 and the data plane VCN 618 can be implemented in the service tenancy 619. In this case, the user, or the customer, of the system may not own or operate either the control plane VCN 616 or the data plane VCN 618. Instead, the IaaS provider may own or operate the control plane VCN 616 and the data plane VCN 618.

The control plane VCN 616 and the data plane VCN 618 may be implemented in the service tenancy 619. This embodiment can enable isolation of networks that may prevent users or customers from interacting with other users', or other customers', resources. Also, this embodiment may allow users, or customers, of the system to store databases privately without needing to rely on public Internet 654, that may not have a sufficient level of threat protection, for storage.

In other embodiments, the LB subnet(s) 622 implemented in the control plane VCN 616 can be configured to receive a signal from the service gateway 646. In this embodiment, the control plane VCN 616 and the data plane VCN 618 may be configured to be called by a customer of the IaaS provider without calling public Internet 654. Customers of the IaaS provider may need this embodiment since database(s) that the customers use may be controlled by the IaaS provider and may be stored on the service tenancy 619. The service tenancy 619 may be isolated from public Internet 654.

FIG. 2 is a block diagram 200 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 710 implemented in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 implemented in the control plane VCN 716. The control plane VCN 716 can be implemented in a service tenancy 719 (e.g., the service tenancy 619 of FIG. 6), and the data plane VCN 718 (e.g., the data plane VCN 618 of FIG. 6) can be implemented in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), and a control plane data tier 728 (e.g., the control plane data tier 628 of FIG. 6) that can include database (DB) subnet(s) 740 (e.g., similar to DB subnet(s) 640 of FIG. 6). The LB subnet(s) 722 implemented in the control plane DMZ tier 720 can be communicatively coupled to the app subnet(s) 726 implemented in the control plane app tier 724 and an Internet gateway 744 (e.g., the Internet gateway 644 of FIG. 6) that can be implemented in the control plane VCN 716. The app subnet(s) 726 can be communicatively coupled to the DB subnet(s) 740 implemented in the control plane data tier 728 and a service gateway 746 (e.g., the service gateway 646 of FIG. 6) and a network address translation (NAT) gateway 748 (e.g., the NAT gateway 648 of FIG. 6). The control plane VCN 716 can include the service gateway 746 and the NAT gateway 748.

The control plane VCN 716 can include a data plane mirror app tier 740 (e.g., the data plane mirror app tier 640 of FIG. 6) that can include app subnet(s) 726. The app subnet(s) 726 implemented in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be implemented in a data plane app tier 746 (e.g., the data plane app tier 646 of FIG. 6). The compute instance 744 can facilitate this communication via the VNIC 742 implemented in the data plane mirror app tier 740 and the VNIC 742 implemented in the data plane app tier 746.

The Internet gateway 744 implemented in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 748 implemented in the control plane VCN 716. The service gateway 746 implemented in the control plane VCN 716 can be communicatively couple to cloud services 756 (e.g., cloud services 656 of FIG. 6).

In some examples, the data plane VCN 718 can be implemented in the customer tenancy 721. In this case, the IaaS provider may provide the control plane VCN 716 for a customer, and the IaaS provider may, for a customer, set up a unique, compute instance 744 that is implemented in the service tenancy 719. A compute instance 744 may allow communication between the control plane VCN 716 implemented in the service tenancy 719 and the data plane VCN 718 that is implemented in the customer tenancy 721. The compute instance 744 may allow resources provisioned in the control plane VCN 716 that is implemented in the service tenancy 719 to be deployed or otherwise used in the data plane VCN 718 that is implemented in the customer tenancy 721.

In other examples, the customer of the IaaS provider may have databases that are implemented in the customer tenancy 721. In this example, the control plane VCN 716 can include the data plane mirror app tier 740 that can include app subnet(s) 726. The data plane mirror app tier 740 can be implemented in the control plane VCN 716, but the data plane mirror app tier 740 may not be implemented in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity implemented in the control plane VCN 716. The customer may need to deploy or otherwise use resources in the data plane VCN 718 that are provisioned in the control plane VCN 716, and the data plane mirror app tier 740 can facilitate the deployment or other usage of resources of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, implemented in the customer tenancy 721, can help isolate the data plane VCN 718 from other customers and from public Internet 754.

In some embodiments, cloud services 756 can be called by the service gateway 746 to access services that may not exist on public Internet 754, on the control plane VCN 716, or on the data plane VCN 718. The connection between cloud services 756 and the control plane VCN 716 or the data plane VCN 718 may not be active or continuous. Cloud services 756 may exist on a different network owned or operated by the IaaS provider. Cloud services 756 may be configured to receive calls from the service gateway 746 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 1” may be located in Region 1 and in “Region 2.” If a call to Deployment 1 is made by the service gateway 746 implemented in the control plane VCN 716 located in Region 1, the call may be transmitted to Deployment 1 in Region 1. In this example, the control plane VCN 716, or Deployment 1 in Region 1, may not be communicatively coupled to, or otherwise in communication with, Deployment 1 in Region 2.

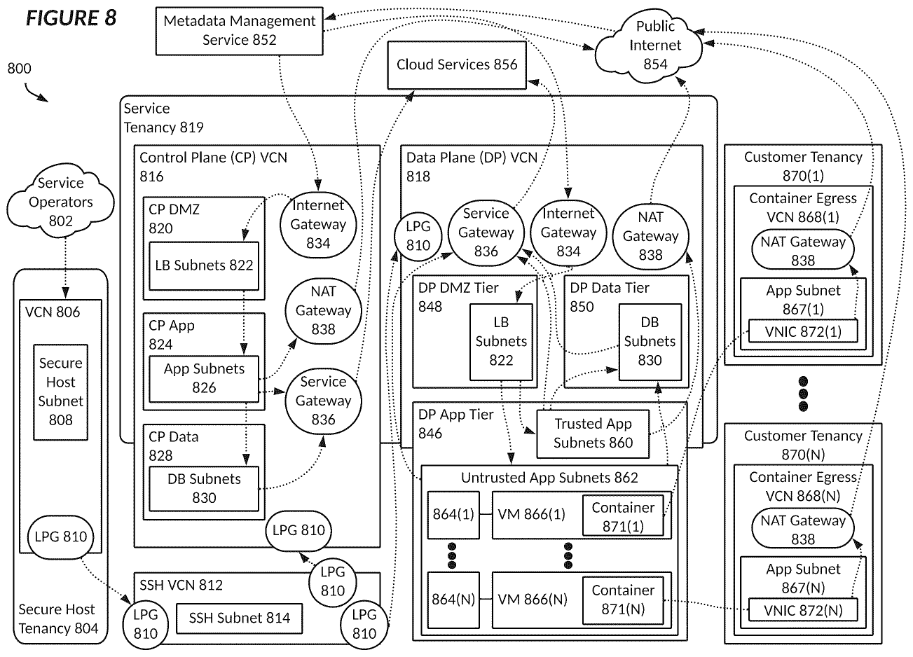

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 implemented in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 implemented in the control plane VCN 816 and to a data plane VCN 818 (e.g., the data plane VCN 618 of FIG. 6) via an LPG 810 implemented in the data plane VCN 818. The control plane VCN 816 and the data plane VCN 818 can be implemented in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), and a control plane data tier 828 (e.g., the control plane data tier 628 of FIG. 6) that can include DB subnet(s) 840. The LB subnet(s) 822 implemented in the control plane DMZ tier 820 can be communicatively coupled to the app subnet(s) 826 implemented in the control plane app tier 824 and to an Internet gateway 844 (e.g., the Internet gateway 644 of FIG. 6) that can be implemented in the control plane VCN 816, and the app subnet(s) 826 can be communicatively coupled to the DB subnet(s) 840 implemented in the control plane data tier 828 and to a service gateway 846 (e.g., the service gateway of FIG. 6) and a network address translation (NAT) gateway 848 (e.g., the NAT gateway 648 of FIG. 6). The control plane VCN 816 can include the service gateway 846 and the NAT gateway 848.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860, untrusted app subnet(s) 862 of the data plane app tier 846, and the Internet gateway 844 implemented in the data plane VCN 818. The trusted app subnet(s) 860 can be communicatively coupled to the service gateway 846 implemented in the data plane VCN 818, the NAT gateway 848 implemented in the data plane VCN 818, and DB subnet(s) 840 implemented in the data plane data tier 850. The untrusted app subnet(s) 862 can be communicatively coupled to the service gateway 846 implemented in the data plane VCN 818 and DB subnet(s) 840 implemented in the data plane data tier 850. The data plane data tier 850 can include DB subnet(s) 840 that can be communicatively coupled to the service gateway 846 implemented in the data plane VCN 818.

The untrusted app subnet(s) 862 can include one or more primary VNICs 864(1)-(N) that can be communicatively coupled to tenant VMs 866(1)-(N). Tenant VMs 866(1)-(N) can be communicatively coupled to a respective app subnets 867(1)-(N) that can be implemented in respective container egress VCNs 868(1)-(N) that can be implemented in respective customer tenancies 870(1)-(N). Respective secondary VNICs 872(1)-(N) can facilitate communication between the untrusted app subnet(s) 862 implemented in the data plane VCN 818 and the app subnet implemented in the container egress VCNs 868(1)-(N). Container egress VCNs 868(1)-(N) can include a NAT gateway 848 that can be communicatively coupled to public Internet 854 (e.g., public Internet 654 of FIG. 6).

The Internet gateway 844 implemented in the control plane VCN 816 and implemented in the data plane VCN 818 can be communicatively coupled to a metadata management service 852 (e.g., the metadata management service 652 of FIG. 6) that can be communicatively coupled to public Internet 854. Public Internet 854 can be communicatively coupled to the NAT gateway 848 implemented in the control plane VCN 816 and implemented in the data plane VCN 818. The service gateway 846 implemented in the control plane VCN 816 and implemented in the data plane VCN 818 can be communicatively couple to cloud services 856.

In some embodiments, the data plane VCN 818 can be integrated with customer tenancies 870(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 846.

Code to execute the function may be executed in the VMs 866(1)-(N), and the code may not be configured to execute anywhere else on the data plane VCN 818. VMs 866(1)-(N) may be connected to one customer tenancy 870(1). Respective containers 871(1)-(N) implemented in the VMs 866(1)-(N) may be configured to execute the code. In this case, there can be a dual isolation (e.g., the containers 871(1)-(N) executing code), where the containers 871(1)-(N) may be implemented in at least the VM 866(1)-(N) that are implemented in the untrusted app subnet(s) 862) that may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completing execution of the code, the IaaS provider may terminate or otherwise dispose of the containers 871(1)-(N).

In some embodiments, the trusted app subnet(s) 860 may execute code that may be owned or operated by the IaaS provider. In this embodiment, the trusted app subnet(s) 860 may be communicatively coupled to the DB subnet(s) 840 and be configured to execute CRUD operations in the DB subnet(s) 840. The untrusted app subnet(s) 862 may be communicatively coupled to the DB subnet(s) 840, but in this embodiment, the untrusted app subnet(s) may be configured to execute read operations in the DB subnet(s) 840. The containers 871(1)-(N) that can be implemented in the VM 866(1)-(N) of a customer and that may execute code from the customer may not be communicatively coupled with the DB subnet(s) 840.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 846. For example, a call to cloud services 856 from the control plane VCN 816 can include a request for a service that can communicate with the data plane VCN 818.

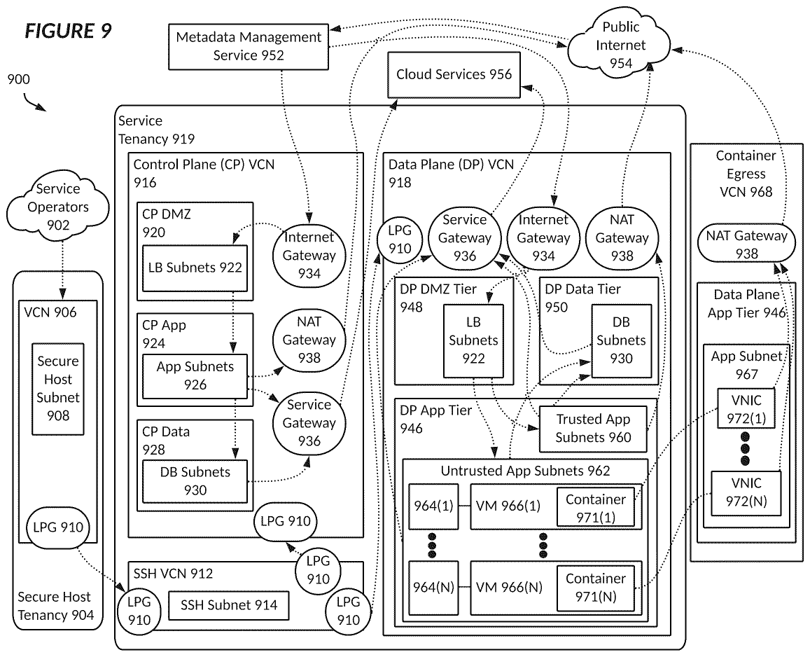

FIG. 9 is a block diagram illustrating another example pattern of an IaaS architecture 900 according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 implemented in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 implemented in the control plane VCN 916 and to a data plane VCN 918 (e.g., the data plane VCN 618 of FIG. 6) via an LPG 910 implemented in the data plane VCN 918. The control plane VCN 916 and the data plane VCN 918 can be implemented in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), and a control plane data tier 928 (e.g., the control plane data tier 628 of FIG. 6) that can include DB subnet(s) 940 (e.g., DB subnet(s) 840 of FIG. 8). The LB subnet(s) 922 implemented in the control plane DMZ tier 920 can be communicatively coupled to the app subnet(s) 926 implemented in the control plane app tier 924 and to an Internet gateway 944 (e.g., the Internet gateway 644 of FIG. 6) that can be implemented in the control plane VCN 916, and the app subnet(s) 926 can be communicatively coupled to the DB subnet(s) 940 implemented in the control plane data tier 928 and to a service gateway 946 (e.g., the service gateway of FIG. 6) and a network address translation (NAT) gateway 948 (e.g., the NAT gateway 648 of FIG. 6). The control plane VCN 916 can include the service gateway 946 and the NAT gateway 948.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 944 implemented in the data plane VCN 918. The trusted app subnet(s) 960 can be communicatively coupled to the service gateway 946 implemented in the data plane VCN 918, the NAT gateway 948 implemented in the data plane VCN 918, and DB subnet(s) 940 implemented in the data plane data tier 950. The untrusted app subnet(s) 962 can be communicatively coupled to the service gateway 946 implemented in the data plane VCN 918 and DB subnet(s) 940 implemented in the data plane data tier 950. The data plane data tier 950 can include DB subnet(s) 940 that can be communicatively coupled to the service gateway 946 implemented in the data plane VCN 918.

The untrusted app subnet(s) 962 can include primary VNICs 964(1)-(N) that can be communicatively coupled to tenant VMs 966(1)-(N) implemented within the untrusted app subnet(s) 962. Tenant VMs 966(1)-(N) can execute code in a respective container 967(1)-(N) and be communicatively coupled to an app subnet 967 that can be implemented in a data plane app tier 946 that can be implemented in a container egress VCN 968. Respective secondary VNICs 972(1)-(N) can facilitate communication between the untrusted app subnet(s) 962 implemented in the data plane VCN 918 and the app subnet 967 implemented in the container egress VCN 968. The container egress VCN 968 can include a NAT gateway 948 that can be communicatively coupled to public Internet 954 (e.g., public Internet 654 of FIG. 6).

The Internet gateway 944 implemented in the control plane VCN 916 and implemented in the data plane VCN 918 can be communicatively coupled to a metadata management service 952 (e.g., the metadata management service 652 of FIG. 6) that can be communicatively coupled to public Internet 954. Public Internet 954 can be communicatively coupled to the NAT gateway 948 implemented in the control plane VCN 916 and implemented in the data plane VCN 918. The service gateway 946 implemented in the control plane VCN 916 and implemented in the data plane VCN 918 can be communicatively couple to cloud services 956.

In some examples, the pattern illustrated by the architecture of block diagram 900 of FIG. 9 may be considered an exception to the pattern illustrated by the architecture of block diagram 800 of FIG. 8 and may be needed for a customer of the IaaS provider if the IaaS provider cannot directly communicate with the customer (e.g., a disconnected region). The respective containers 971(1)-(N) that are implemented in the VMs 966(1)-(N) for a customer can be accessed in real-time by the customer. The containers 971(1)-(N) may be configured to make calls to respective secondary VNICs 972(1)-(N) implemented in app subnet(s) 967 of the data plane app tier 946 that can be implemented in the container egress VCN 968. The secondary VNICs 972(1)-(N) can transmit the calls to the NAT gateway 948 that may transmit the calls to public Internet 954. In this example, the containers 971(1)-(N) that can be accessed in real time by the customer can be isolated from the control plane VCN 916 and can be isolated from other entities implemented in the data plane VCN 918. The containers 971(1)-(N) may also be isolated from resources from other customers.

In other examples, the customer can use the containers 971(1)-(N) to call cloud services 956. In this example, the customer may execute code in the containers 971(1)-(N) that request a service from cloud services 956. The containers 971(1)-(N) can transmit this request to the secondary VNICs 972(1)-(N) that can transmit the request to the NAT gateway 948 that can transmit the request to public Internet 954. Public Internet 954 can transmit the request to LB subnet(s) 922 implemented in the control plane VCN 916 via the Internet gateway 944. In response to determining the request is valid, the LB subnet(s) can transmit the request to app subnet(s) 926 that can transmit the request to cloud services 956 via the service gateway 946.

It should be appreciated that IaaS architectures 600, 700, 800, and 900 may include components that are different and/or additional to the components shown in the figures.

Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various VMs and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a VM, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a VM, a container, and/or a software application. Network resources are shared amongst multiple clients. Clients request computing services from a computer network independently of other clients.

Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (Saas), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for an entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, VMs, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks.

Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network).

The second encapsulation tunnel endpoint decapsulates the outer packet to obtain the original packet transmitted by the source device. The original packet is transmitted from the second encapsulation tunnel endpoint to the destination device in the same particular overlay network.

### 8. Computer System

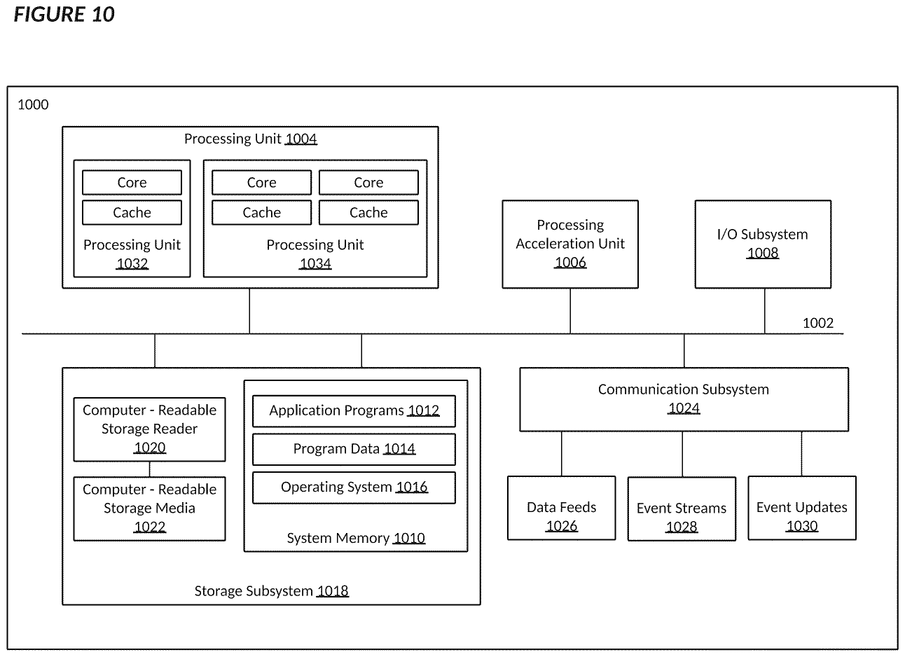

FIG. 10 illustrates an example computer system 1000. An embodiment of the disclosure may be implemented upon the computer system 1000. As shown in FIG. 10, computer system 1000 includes a processing unit 1004 that communicates with peripheral subsystems via a bus subsystem 1002. These peripheral subsystems may include a processing acceleration unit 1006, a I/O subsystem 1008, a storage subsystem 1018, and a communications subsystem 1024. Storage subsystem 1018 includes tangible computer-readable storage media 1022, computer-readable storage reader 1020 and a system memory 1010.

Bus subsystem 1002 provides a mechanism for letting the various components and subsystems of computer system 1000 to communicate with other components and subsystems as intended. Although bus subsystem 1002 is shown schematically as a single bus, alternative embodiments of the bus subsystem may utilize multiple buses. Bus subsystem 1002 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the Institute of Electrical and Electronics Engineers (IEEE) P1486.1 standard.

Processing unit 1004 controls the operation of computer system 1000. Processing unit 1004 can be implemented as one or more integrated circuits (e.g., a conventional microprocessor or microcontroller). One or more processors may be implemented in processing unit 1004. These processors may include single core or multicore processors. In certain embodiments, processing unit 1004 may be implemented as one or more independent sub processing units 1042 and/or 1044 with single or multicore processors implemented in one or more processing units. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, the program code to be executed can be wholly or partially implemented in processing unit 1004 and/or in storage subsystem 1018. Through suitable programming, processing unit 1004 can provide various functionalities described above. Computer system 1000 may additionally include a processing acceleration unit 1006 that can include a digital signal processor (DSP), a special-purpose processor, and/or the like.

I/O subsystem 1008 may include user interface input devices and user interface output devices. User interface input devices may include a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices, such as the Microsoft Kinect® motion sensor that enables users to control and interact with an input device, such as the Microsoft Xbox® 460 game controller, through a natural user interface using gestures and spoken commands. User interface input devices may also include eye gesture recognition devices, such as the Google Glass® blink detector, that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (4D) mice, joysticks or pointing sticks, gamepads and graphic tablets, and audio/visual devices, such as speakers, digital cameras, digital camcorders, portable media players, webcams, image scanners, fingerprint scanners, barcode reader 4D scanners, 4D printers, laser rangefinders, and eye gaze tracking devices. Additionally, user interface input devices may include medical imaging input devices, such as computed tomography, magnetic resonance imaging, position emission tomography, or medical ultrasonography devices. User interface input devices may also include audio input devices, such as MIDI keyboards, digital musical instruments and the like.

User interface output devices may include a display subsystem, indicator lights, or non-visual displays, such as audio output devices. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 1000 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 1000 may comprise a storage subsystem 1018 that provides a tangible, non-transitory, computer-readable storage medium for storing software and data constructs that provide the functionality of the embodiments described in this disclosure. The software can include programs, code modules, instructions, scripts, etc., that, when executed by one or more cores or processors of processing unit 1004, provide the functionality described above. Storage subsystem 1018 may also provide a repository for storing data used in accordance with the present disclosure.

As depicted in the example in FIG. 10, storage subsystem 1018 can include various components, including a system memory 1010, computer-readable storage media 1022, and a computer readable storage media reader 1020. System memory 1010 may store program instructions, such as application programs 1012, that are loadable and executable by processing unit 1004. System memory 1010 may also store data, such as program data 1014, that is used during the execution of the instructions and/or data that is generated during the execution of the program instructions. Various programs may be loaded into system memory 1010 including, but not limited to, client applications, Web browsers, mid-tier applications, relational database management systems (RDBMS), VMs, containers, etc.

System memory 1010 may also store an operating system 1016. Examples of operating system 1016 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, and Palm® OS operating systems. In certain implementations where computer system 1000 executes one or more VMs, the VMs along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 1010 may include a basic input/output system (BIOS) including basic routines that help to transfer information between elements within computer system 1000 such as during start-up.

Computer-readable storage media 1022 may represent remote, local, fixed, and/or removable storage devices plus storage media for temporarily and/or more permanently including and storing computer-readable information for use by computer system 1000, including instructions executable by processing unit 1004 of computer system 1000.

Computer-readable storage media 1022 can include any appropriate media known or used in the field, including storage media and communication media, such as but not limited to volatile and non-volatile, removable and non-removable media implemented in any method or technology for storage and/or transmission of information. This can include tangible, computer-readable storage media, such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible, computer-readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include solid-state drives (SSD) based on non-volatile memory, such as flash-memory based SSDs, enterprise flash drives, solid state ROM, and the like, SSDs based on volatile memory, such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated, computer-readable media may provide non-volatile storage of computer-readable instructions, data structures, program modules, and other data for computer system 1000.

Machine-readable instructions executable by one or more processors or cores of processing unit 1004 may be stored on a non-transitory, computer-readable storage medium. A non-transitory, computer-readable storage medium can include physically tangible memory or storage devices that include volatile memory storage devices and/or non-volatile storage devices. Examples of non-transitory, computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments, communications subsystem 1024 can include radio frequency (RF) transceiver components to access wireless voice and/or data networks (e.g., using cellular telephone technology, advanced data network technology, such as 4G, 4G, or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1040, and the like on behalf of one or more users who may use computer system 1000.

By way of example, communications subsystem 1024 may be configured to receive data feeds 1026 in real time from users of social networks and/or other communication services, such as Twitter® feeds, Facebook® updates, web feeds, such as Rich Site Summary (RSS) feeds, and/or real-time updates from one or more third party information sources.

Additionally, communications subsystem 1024 may be configured to receive data in the form of continuous data streams. The continuous data streams may include event streams 1028 of real-time events and/or event updates 1040 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1040, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in FIG. 10 is intended as a non-limiting example. Many other configurations having more or fewer components than the system depicted in FIG. 10 are possible. For example, customized hardware might also be used and/or particular elements might be implemented in hardware, firmware, software (including applets), or a combination.

Furthermore, connection to other computing devices, such as network input/output devices, may be employed. Based on the disclosure and teachings provided herein, a person of ordinary skill in the art will appreciate other ways and/or methods to implement the various embodiments.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
receiving natural language input describing desired protection for a target cloud resource;
submitting the natural language input to an artificial intelligence (AI) model;
receiving, from the AI model, a set of one or more protection levels for a physical computing device that is to be configured to execute or store at least a portion of the target cloud resource, the set of one or more protection levels for the physical computing device being selected from a plurality of available protection capabilities based on the natural language input;
identifying one or more physical computing devices, from a candidate set of physical computing devices, that currently meet the set of one or more protection levels received from the AI model;
responsive to the one or more physical computing devices meeting the set of one or more protection levels, selecting the one or more physical computing devices for executing or storing the portion of the target cloud resource; and
initiating the executing or storing of the portion of the target cloud resource on the one or more physical computing devices;
wherein the method is performed by at least one device comprising a hardware processor.

2. The method of claim 1, wherein the set of one or more protection levels are selected from the plurality of available protection capabilities at least by determining that the set of one or more protection levels can implement protection requirements defined by the natural language input.

3. The method of claim 1, wherein receiving the set of one or more protection levels from the AI model comprises receiving a protection policy that is determined by the AI model based in part on the natural language input, wherein the protection policy includes the set of one or more protection levels.

4. The method of claim 1, wherein:
the natural language input defines a temporal characteristic indicating that at least one of the set of one or more protection levels is needed for the one or more physical computing devices during a period of time when the one or more physical computing devices are executing or storing the portion of the target cloud resource, and
the method further comprises:
monitoring environmental conditions associated with the one or more physical computing devices to detect the at least one of the set of one or more protection levels is being met for the one or more physical computing devices,
wherein initiating the executing or storing of the portion of the target cloud resource on the one or more physical computing devices is responsive to detecting the at least one of the set of one or more protection levels.

5. The method of claim 1, wherein selecting the one or more physical computing devices comprises selecting a worker node, implemented by the one or more physical computing devices, from a plurality of worker nodes respectively implemented by a plurality of physical computing devices.

6. The method of claim 5, wherein selecting the worker node comprises configuring a Kubernetes cluster to select the worker node from a set of worker nodes being executed on physical computing devices that meet the set of one or more protection levels.

7. The method of claim 5, further comprising: terminating the execution or storage of the portion of the cloud resource by the worker node in response to determining that the protection level has not been met for a threshold period of time.

8. The method of claim 5, wherein selecting the one or more physical computing devices comprises:
responsive to determining that an insufficient number of worker nodes are executing candidate physical computing devices that meet the protection level, selecting a set of worker nodes that are executing on a set of one or more physical computing devices that partially meet the protection level until a minimum number of worker nodes are selected for executing or storing the portion of the target cloud resource.

9. The method of claim 1, wherein:
the set of one or more protection levels comprise a score and/or weight corresponding to each of a plurality of protection dimensions; and
selecting the one or more physical computing devices based on the set of one or more protection levels received from the AI model comprises:
submitting the one or more protection levels and system configuration parameters to a selection component; and
receiving from the selection component a selection of (a) the one or more physical computing devices and/or (b) a compute resource for executing the portion of the target cloud resource, the compute resource being executed on the one or more physical computing devices.

10. The method of claim 1, further comprising: selecting a subgroup of two or more nodes from a candidate set of nodes for executing or storing the portion of the target cloud resource.

11. One or more non-transitory computer-readable media comprising instructions that, when executed by one or more hardware processors, cause performance of operations comprising:
receiving natural language input describing desired protection for a target cloud resource;
submitting the natural language input to an artificial intelligence (AI) model;
receiving, from the AI model, a set of one or more protection levels for a physical computing device that is to be configured to execute or store at least a portion of the target cloud resource, the set of one or more protection levels for the physical computing device being selected from a plurality of available protection capabilities based on the natural language input;
identifying one or more physical computing devices, from a candidate set of physical computing devices, that currently meet the set of one or more protection levels received from the AI model;
responsive to the one or more physical computing devices meeting the set of one or more protection levels, selecting the one or more physical computing devices for executing or storing the portion of the target cloud resource; and
initiating the executing or storing of the portion of the target cloud resource on the one or more physical computing devices.

12. The one or more non-transitory computer-readable media of claim 11, wherein the set of one or more protection levels are selected from the plurality of available protection capabilities at least by determining that the set of one or more protection levels can implement protection requirements defined by the natural language input.

13. The one or more non-transitory computer-readable media of claim 11, wherein receiving the set of one or more protection levels from the AI model comprises receiving a protection policy that is determined by the AI model based in part on the natural language input, wherein the protection policy includes the set of one or more protection levels.

14. The one or more non-transitory computer-readable media of claim 11, wherein:
the natural language input defines a temporal characteristic indicating that at least one of the set of one or more protection levels is needed for the one or more physical computing devices during a period of time when the one or more physical computing devices are executing or storing the portion of the target cloud resource, and
the operations further comprise:
monitoring environmental conditions associated with the one or more physical computing devices to detect the at least one of the set of one or more protection levels is being met for the one or more physical computing devices,
wherein initiating the executing or storing of the portion of the target cloud resource on the one or more physical computing devices is responsive to detecting the at least one of the set of one or more protection levels.

15. The one or more non-transitory computer-readable media of claim 11, wherein selecting the one or more physical computing devices comprises selecting a worker node, implemented by the one or more physical computing devices, from a plurality of worker nodes respectively implemented by a plurality of physical computing devices.

16. The one or more non-transitory computer-readable media of claim 15, wherein selecting the worker node comprises configuring a Kubernetes cluster to select the worker node from a set of worker nodes being executed on physical computing devices that meet the set of one or more protection levels.

17. The one or more non-transitory computer-readable media of claim 15, wherein the operations further comprise: terminating the execution or storage of the portion of the cloud resource by the worker node in response to determining that the protection level has not been met for a threshold period of time.

18. The one or more non-transitory computer-readable media of claim 15, wherein selecting the one or more physical computing devices comprises:
responsive to determining that an insufficient number of worker nodes are executing candidate physical computing devices that meet the protection level, selecting a set of worker nodes that are executing on a set of one or more physical computing devices that partially meet the protection level until a minimum number of worker nodes are selected for executing or storing the portion of the target cloud resource.

19. The one or more non-transitory computer-readable media of claim 11, wherein:
the set of one or more protection levels comprise a score and/or weight corresponding to each of a plurality of protection dimensions; and
selecting the one or more physical computing devices based on the set of one or more protection levels received from the AI model comprises:
submitting the one or more protection levels and system configuration parameters to a selection component; and
receiving from the selection component a selection of (a) the one or more physical computing devices and/or (b) a compute resource for executing the portion of the target cloud resource, the compute resource being executed on the one or more physical computing devices.

20. The one or more non-transitory computer-readable media of claim 11, wherein the operations further comprise comprising: selecting a subgroup of two or more nodes from a candidate set of nodes for executing or storing the portion of the target cloud resource.

21. A system comprising:
one or more hardware processors;
one or more non-transitory computer-readable media; and
program instructions stored on the one or more non-transitory computer-readable media that, when executed by the one or more hardware processors, cause the system to:
receive natural language input describing desired protection for a target cloud resource;
submit the natural language input to an artificial intelligence (AI) model;
receive, from the AI model, a set of one or more protection levels for a physical computing device that is to be configured to execute or store at least a portion of the target cloud resource, the set of one or more protection levels for the physical computing device being selected from a plurality of available protection capabilities based on the natural language input;
identify one or more physical computing devices, from a candidate set of physical computing devices, that currently meet the set of one or more protection levels received from the AI model;
responsive to the one or more physical computing devices meeting the set of one or more protection levels, select the one or more physical computing devices for executing or storing the portion of the target cloud resource; and
initiate the executing or storing of the portion of the target cloud resource on the one or more physical computing devices.
